(19) United States
(12) Patent Application Publication
(10) Pub. No.: US 2004/0037960 A1
(43) Pub. Date: Feb. 26, 2004

(54) Liquid transfer device, liquid transfer method and liquid remaining amount monitoring method of liquid transfer device

(75) Inventors: Yoshiaki Suzuki, Kanagawa (JP); Masashi Ogawa, Kanagawa (JP); Yoshinori Sato, Tokyo (JP); Hiromi Furuya, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/606,237

(22) Filed: Jun. 26, 2003

(30) Foreign Application Priority Data
Jun. 27, 2002 (JP) 2002-188789
Jun. 27, 2002 (JP) 2002-188790
Jun. 27, 2002 (JP) 2002-188791
Jun. 27, 2002 (JP) 2002-188792
Oct. 31, 2002 (JP) 2002-318907

(51) Int. Cl. B05D 5/00

(52) U.S. Cl. 427/256

(57) ABSTRACT

A liquid transfer device transferring liquid for enhancing durability of an image on a surface of a printed product printed with ink has a liquid transfer member having a transfer surface contacting the surface of the printed product and transferring the liquid thereto. The liquid transfer member includes a liquid accumulating portion, formed from a sheet form member, accumulating the liquid and a restricting portion supplying the liquid to the transfer surface with restriction. The device further includes a holding member receiving and holding the liquid transfer member. The holding member includes a surface supporting frame formed with an opening exposing a porous film, and a dish shaped receptacle member having a flange mating with a lower surface of the surface supporting frame. The liquid transfer member is housed within a receptacle space defined by the receptacle member and the surface supporting frame.

This application claims priority from Japanese Patent Application Nos. 2002-188789 filed Jun. 27, 2002, 2002-188790 filed Jun. 27, 2002, 2002-188791 filed Jun. 27, 2002, 2002-188792 filed Jun. 27, 2002 and 2002-318907 filed Oct. 31, 2002, which are incorporated hereinto by reference.

### BACKGROUND OF THE INVENTION

1. Field of the Invention

The present invention relates generally to a liquid transfer device and a liquid transfer method. More particularly, the invention relates to a liquid transfer device and a liquid transfer method for transferring or applying a liquid, such as an image protecting liquid or the like to a printing surface of a printing medium printed by an ink-jet printing apparatus. The invention further relates to a liquid remaining amount monitoring method for such a liquid transfer device.

2. Description of the Related Art

Originally, an ink-jet printing apparatus has mainly been used for printing texts of characters or the like on a printing medium, such as paper or the like. In the recent years, associating with progress of technology in down-sizing of droplet and in increasing of tone levels of multiple tone, the ink-jet printing apparatus is also used for formation of photographic image. Also, nowadays, associating with spreading of digital cameras, range of application of the ink-jet printing apparatus has been extended to field of photographic printing, graphic art and so on. Aside from spreading of such ink-jet printing apparatus, it has been becoming important problem how to improve keeping quality and to expand life of the image formed by such ink-jet printing apparatus. Namely, a printed product printed by depositing dye-type ink on an appropriate medium (printing medium), has good color developing ability, but is lower in durability and keeping quality of image. On the other hand, a printed product printed by pigment-type ink is superior in keeping quality but is inferior in color development ability and abrasion-resistance.

As a method for improving keeping quality of the image, it is at first considered to form a highly durable image using the pigment-type ink. As another approach, it is considered to protect the image formed by coloring agent having low durability, such as dye-type ink with other member. As the latter method, it has been known to laminate a film forming resin, such as acryl type protective film, sheet material or the like, over the image.

However, when the conventional protection method, such as covering the printed product with glass or laminating resin over the printed product, is employed, the image is viewed across the film or glass and raw image cannot be viewed directly. Therefore, in such a protecting method, image texture is significantly sacrificed to hinder directly viewing the image.

On the other hand, Japanese Patent Application Laid-Open No. 9-048180 (1997) discloses a treatment for a measure for bleeding of image due to deposition of water droplets on the printed product or degradation of image due to irradiation of ultraviolet ray. Even when a printing medium provided with water resistance or light fastness against ultraviolet ray by the treatment disclosed in the above-identified publication is used, it has been found that fatigue by moisture and/or minor component gas, such as ozone, nitrogen oxide, sulfur oxide or the like contained in the air occurs, as certain time elapsed. It has been demanded to establish a technology to improve durability of the image with maintaining image texture of the image (raw image) formed by the ink-jet printing apparatus and so on as early as possible. In addition, in the light of degree of spreading of the ink-jet printing apparatuses and digital cameras, such technology has to be convenient to be easily handled by a user.

### SUMMARY OF THE INVENTION

It is an object of the present invention to provide a liquid transfer device and a liquid transfer method which can enhance durability of an image with maintaining image texture of a raw image by transferring liquid to a printing medium on which an image is printed without laminating a protective member, such as glass, film or the like, on the image.

Another object of the present invention is to provide a liquid holding apparatus which can hold a liquid without local concentration over entire liquid holding portion in the liquid holding apparatus for the liquid transfer device and so on.

A further object of the present invention is to provide a liquid transfer device which can improve durability of the image with maintaining image texture and can improve usability.

A still further object of the present invention is to provide a liquid transfer device which can appropriately hold the liquid within the liquid transfer device without causing leakage of the liquid.

The inventors have researched and developed an apparatus and method which permits directly viewing a raw image without interposing a transparent layer, such as glass, film or the like on a printing medium, can maintain image texture for a long period and can transfer an appropriate amount of liquid without depositing the liquid on hand.

In order to achieve any one of the foregoing objects, according to one aspect of the present invention, there is provided a liquid transfer device transferring liquid for enhancing durability of an image on a printed surface of a printed product printed with ink, comprising:

a liquid transfer member having a transfer surface contacting the printed surface of the printed product and transferring the liquid on the printed surface of the printed product,

the liquid transfer member including

a liquid accumulating portion accumulating the liquid; and

a restricting portion supplying the liquid in the liquid accumulating portion to the transfer surface with restriction.

Here, the restricting portion may be formed from a porous film formed with fine pores.

The liquid transfer device may further comprise a holding member for receiving and holding the liquid transfer member.

The liquid accumulating portion may be formed from a sheet form member having uniform density.

The holding member may include a surface supporting frame formed with an opening portion exposing the restricting portion and a dish shaped receptacle member having a flange mating with a lower surface of the surface supporting frame, the liquid transfer member may be received within a receptacle space defined by the receptacle member and the surface supporting frame.

The liquid accumulating portion may be formed from a sheet form member having different density in thickness direction thereof.

The liquid accumulating portion may be formed from a sheet form member provided with treatment for continuously varying a density in thickness direction with a predetermined gradient.

The liquid accumulating portion may be formed by laminating a plurality of sheet form members having different densities.

Capillary forces of the liquid accumulating portion, the porous film and the printed surface of the printed product may be set for establishing a relationship:

liquid accumulating portion <porous film< printed surface of printed product.

Densities of respective sheet form members forming the liquid accumulating portion may be set for producing greater capillary force at closer position to the transfer surface.

The liquid accumulating portion may be formed with a first layer and a second layer having different densities, the first layer may be located at a position more distant from the transfer surface than the second layer, and the first layer may have greater density than the second layer.

The liquid transfer device may further comprise a holding member receiving the liquid transfer member, the holding member may include a surface supporting frame having an opening portion, into which the first layer covered with the restricting portion is inserted, and a dish shaped receptacle member having a flange mating with a lower surface of the surface supporting frame,

the second layer may be received with a receptacle space defined by the receptacle member and the surface supporting frame and the first layer covered by the restricting portion projects upwardly from a surface of the surface supporting frame, and a surface of the restricting portion may form a transfer zone.

The first layer and the second layer may be formed from a fibrous body or a foamed sponge body, a density of the first layer may be in a range of 0.05 to 0.5 g/cc, and a density of the second layer may be in a range of 0.01 to 0.2 g/cc.

The porous film may have a thickness of 10 to 200 μm, and a diameter of fine pore may be 0.1 to 3 μm.

The liquid transfer member may have a normally flat transfer surface, when the printed product is mounted and urged onto the transfer surface, the liquid accumulating portion may be elastically deformed corresponding to a curved shape of the printed surface of the printed product so that the curved printed surface and the transfer surface are contacted over entire area.

Stripe form grooves may be formed on a bottom surface of the liquid accumulating portion.

According to the invention with the construction set forth above, it becomes possible to transfer an appropriate amount of liquid just in proportion to a printed product on which an image is printed with ink, so that durability of the image, which has been big problems to be solved in the ink-jet printing field, can be enhanced to be greater than that of silver salt picture without forming an optical film, such as glass, resin and so forth on the printed product. Thus, a digital image of superior image quality can be formed at low cost utilizing a superior function of the ink-jet printing apparatus.

On the other hand, as applicable objects, printed products using various sizes of medium (printed medium), such as

Photograph size called L size (89 mm×119 mm)

Post card (100 mm×148 mm)

2L size (double of L side) (119 mm×178 mm)

A4 size (210 mm×297 mm),

may be listed, and an appropriate amount of liquid can be transferred to such various size of printed products.

On the other hand, in another aspect of the present invention, there is provided a liquid holding device holding a liquid by capillary force, comprising:

a plurality of divided liquid holding members, each holding the liquid by capillary force thereof,

wherein each of the plurality of divided liquid holding members are determined in capillary force and size so that a total liquid amount to be held by the divided liquid holding members is greater than a liquid amount to be held by a liquid holding member before division, irrespective of attitude of the liquid holding device.

Here, each of the plurality of liquid holding members may be determined in size so as to hold the liquid over substantially entire region of the liquid holding member irrespective of attitude of the liquid holding device.

Further, there is provided a liquid transfer device transferring liquid to an object to be transferred the liquid, comprising:

a transfer film permeating the liquid and contacting the object to be transferred the liquid for transferring the permeating liquid; and

an accumulating portion including a plurality of divided accumulating members accumulating the liquid to be supplied to the transfer film and permeating therethrough, by capillary forces thereof, each of the plurality of accumulating members having such capillary forces and sizes that a total liquid amount to be held by the divided liquid holding members is greater than a liquid amount to be held by a liquid holding member before division, irrespective of attitude of the liquid holding device.

Here, each of the plurality of liquid accumulating members may be set at a size for accumulating the liquid over substantially entire region of the liquid accumulating member irrespective of attitude of the liquid transfer device.

The plurality of liquid accumulating members may be dividedly arranged so that liquids accumulated in each of the plurality of liquid accumulating members are communicated with each other as depressed through the transfer film.

The plurality of liquid accumulating members may be separated from each other by partitioning walls. Thicknesses of the partitioning walls may be in a range of 0.1 mm to 1 mm.

The plurality of liquid accumulating members may be processed at an accuracy so that a length of burr possibly formed during processing becomes less than the thickness of the partitioning wall.

With the construction set forth above, a plurality of holding members or liquid accumulating members holding the liquid by capillary force can hold a liquid amount greater than the liquid amount to be held by total volume of the plurality of holding member or the liquid accumulating members at a predetermined attitude of the liquid holding device or the liquid accumulating device, irrespective of the attitude of the liquid holding device or the liquid accumulating device. Therefore, even when respective holding members or the liquid accumulating members hold the liquid entirely for holding the liquid in the amount to be held or in necessary amount for transfer, leakage of the liquid from the liquid holding device or the liquid accumulating device can be prevented even when the attitude of the liquid holding device or the liquid accumulating device is orienting the longitudinal direction in vertical direction, for example.

On the other hand, such a liquid transfer device is preferably constructed to perform liquid transfer for a plurality of times for various sizes of printing medium as set forth above. In view of size, cost or the like of the entire device, amount of the liquid to be received in the absorbing body has a given limit. Associating with this, there is a given limit even for number of times of transfer of the liquid for the object to be transferred the liquid.

In this case, it should be inconvenient for users not to see the remaining amount of the liquid in the absorbing body. Particularly, since the liquid is basically transparent, it is not easy for the user to visually check whether the liquid is certainly transferred to the printed product. In practice, it is possible to occur that the liquid transfer operation is performed despite of the fact that the liquid is not remained in the absorbing body.

In view of this, a liquid transfer device according to the present invention which transfers a predetermined liquid to an object to be transferred the liquid, may comprise:

a porous body having a transfer zone to be contacted with the object to be transferred the liquid;

an absorbing body arranged in contact with the porous body and capable of absorbing and holding the liquid; and

a colored member embedded in the absorbing body and being visible through the absorbing body,

wherein a liquid remaining amount in the absorbing body can be monitored on the basis of view condition of the colored member variable depending upon transmission coefficient of the absorbing body variable according to increase number of times of transfer of the liquid.

In this liquid transfer device, view condition of the colored member through the absorbing body is varied depending upon transmission coefficient of the absorbing body variable according to increase of number of times of liquid transfer. Therefore, user may perform liquid transfer operation for the object to be transferred the liquid with monitoring the liquid remaining amount in the absorbing body. As a result, with the liquid transfer device, it becomes possible to enhance durability of the image with maintaining image texture of the image by certainly and uniformly transferring the liquid to the object, significantly improving workability in the liquid transfer operation.

The absorbing body may be supported by an essentially transparent receptacle member, and the colored member may be visible through the receptacle member and the absorbing body.

The absorbing body may include a first absorbing body having a first density and a second absorbing body having a second density lower than the first density, and the colored member may be visible through the second absorbing body.

An embedding height of the colored member in the absorbing body may be determined so as to detect lacking of liquid remaining amount in the absorbing body from view condition of the colored member at a timing where a predetermined times of liquid transfer is completed.

The absorbing body may include a first absorbing body and a second absorbing body, and thickness of at least one of the first absorbing body and the second absorbing body maybe determined so as to detect lacking of remaining liquid amount in the absorbing body from view condition of the colored member at a timing where a predetermined times of liquid transfer is completed.

The colored member may have a plurality of holes permitting flow of the liquid.

The colored member may have an external dimension of at least 5 mm square.

The colored member may be embedded in the absorbing body at a position not overlapping with the transfer zone.

The colored member may be embedded in the absorbing body at a position overlapping with the transfer zone.

The colored member may be embedded in the absorbing body in a tilted state relative to the surface of the porous body so that lacking of liquid remaining amount in the absorbing body can be perceived from view condition of the colored member at a time of completion of transfer for a predetermined number of times.

The colored member can be seen through the porous body and the absorbing body.

The absorbing body may include a first absorbing body having a first density and a second absorbing body having a second density lower than the first density, thickness of at least one of the first absorbing body and the second absorbing body may be determined so that lacking of liquid remaining amount in the absorbing body can be perceived from viewing condition of the colored member at a time of completion of transfer for a predetermined number of times.

According to a further aspect of the present invention, there is provided a liquid remaining amount monitoring method of a liquid transfer device having a porous body having a transfer zone contacting an object to be transferred liquid and an absorbing body arranged in contact with the porous body and capable of absorbing and holding a predetermined liquid, and transferring the liquid to the object arranged in the transfer zone, wherein the method comprising the steps of:

embedding a colored member in the absorbing body to be viewed through the absorbing body, and

monitoring a liquid remaining amount in the absorbing body on the basis of view condition of the colored member depending upon a transmission coefficient of the absorbing body variable according to increase of number of times of transfer of the liquid.

In this case, it is preferred to embed the colored member in a tilted state with respect to the surface of the porous member.

According to a still further aspect of the present invention, there is provided

a liquid transfer device transferring liquid for enhancing durability of an image for a printed surface of a printed product printed with ink, comprising:

a liquid transfer member transferring the liquid to the printed surface of a printing medium by contacting the printed surface of the printing medium on a transfer surface externally exposed,

the liquid transfer member having a liquid accumulating member accumulating the liquid by capillary force and having a primary surface positioning the transfer surface at an upper portion, the liquid accumulating member having a dimension greater than a dimension where an initial accumulation amount corresponding to a predetermined number of times to transfer the liquid becomes a maximum absorbing capacity.

Here, the liquid accumulating member may be determined a dimension so that an amount of the liquid to be held without causing leakage even upon exposing to atmosphere becomes the initial accumulation amount.

The liquid accumulating member may be determined a dimension so that an amount of the liquid to be held without causing leakage even when the primary surface is oriented in vertical direction, becomes the initial accumulation amount.

The liquid accumulating member may be determined a dimension in a direction of the primary surface so that the primary surface becomes larger than the transfer surface.

The liquid accumulating member may have a layer having relatively high density and in which the transfer surface is positioned, and a layer having relatively low density and in which the primary surface is arranged, the liquid accumulating member may be determined a dimension so that a sum of the amounts of liquid to be held without causing leakage in each of the layers becomes the initial accumulation amount.

A dimension of the layer having relatively low density in a direction of the primary surface may be determined so that the primary surface of the layer having relatively low density is larger than a bottom surface of the layer having relatively high density where the transfer surface is positioned and mating with the primary surface.

A porous film formed with fine pores restrictingly supplying the liquid exuding from the liquid accumulating member, may be arranged on the transfer surface.

The initial accumulation amount may be determined with taking an amount of liquid to be held by the porous film without causing leakage, and the dimension of the liquid accumulating member may be determined corresponding to the initial accumulation amount.

Grooves for smoothly moving the liquid to the position corresponding to the transfer surface may be provided in the liquid accumulating member.

According to the invention with the construction set forth above, it becomes possible to transfer an appropriate amount of liquid just in proportion to a printed product on which an image is printed with ink, so that durability of the image, which has been big problems to be solved in the ink-jet printing field, can be enhanced to be greater than that of silver salt picture without forming an optical film, such as glass, resin and so forth on the printed product. Thus, a digital image of superior image quality can be formed at low cost utilizing a superior function of the ink-jet printing apparatus.

On the other hand, it is possible to perform a protection process of the image of the printed product conveniently and with high operability so that a protected raw image can be directly viewed.

Furthermore, by using the liquid accumulating member which can hold appropriate amount of liquid without causing leakage, any liquid leakage can be prevented at any attitude of the liquid transfer device in handling or storing in non-use state.

The above and other objects, effects, features and advantages of the present invention will become more apparent from the following description of embodiments thereof taken in conjunction with the accompanying drawings.

### BRIEF DESCRIPTION OF THE DRAWINGS

FIGS. 1A, 1B and 1C are sections showing conditions of a printed product before and after transferring a protecting liquid on the printed product, wherein FIG. 1A shows a condition before transferring the liquid, FIG. 1B shows a condition immediately after transferring of the liquid and FIG. 1C shows a condition 2 to 5 minutes after transferring of the liquid;

FIGS. 2A and 2B are enlarged sections showing a condition of the printed product before and after transferring of an appropriate amount of the liquid on the printed product M by the first embodiment of a liquid transfer device according to the present invention, wherein FIG. 2A shows a condition of the printed product in which a coloring agent penetrates into a receptacle layer, and FIG. 2B shows a condition where an appropriate amount of liquid is transferred and the liquid propagates over the entire receptacle layer;

FIG. 3A is a perspective view showing a construction of the first embodiment of a liquid transfer device according to the present invention;

FIG. 3B is a section of the liquid transfer device shown in FIG. 3A;

FIG. 4 is an exploded perspective view of the liquid transfer device shown in FIGS. 3A and 3B;

FIGS. 5A to 5G are sections showing assembling process of the liquid transfer device shown in FIGS. 3A and 3B;

FIG. 6A is a perspective view showing a construction of the first modification of the first embodiment of the liquid transfer device;

FIG. 6B is a cross section of the liquid transfer device shown in FIG. 6A;

FIG. 7 is an exploded perspective view of the liquid transfer device shown in FIGS. 6A and 6B;

FIGS. 8A to 8G are sections showing assembling process of the liquid transfer device shown in FIGS. 6A and 6B;

FIG. 9A is a perspective view showing a construction of the second modification of the first embodiment of the liquid transfer device;

FIG. 9B is a cross section of the liquid transfer device shown in FIG. 9A;

FIG. 10 is an exploded perspective view of the liquid transfer device shown in FIGS. 9A and 9B;

FIGS. 11A to 11G are sections showing assembling process of the liquid transfer device shown in FIGS. 9A and 9B;

FIGS. 12A to 12D are illustrations showing liquid transfer operation to be performed by the liquid transfer device shown in FIGS. 3A, 3B, 6A, 6B, 9A and 9B;

FIGS. 13A and 13B are illustrations for explaining manner of weeping of the liquid in the first modification of the first embodiment of the liquid transfer device;

FIGS. 14A and 14B are illustrations for explaining property of a liquid accumulating member in the embodiments of the present invention;

FIGS. 15A to 15C are diagrammatic illustrations for explaining view through conditions of the coloring agent depending upon variation of transmission coefficient of an absorbent in the second modification of the first embodiment;

FIGS. 16A and 16B are illustrations showing the second embodiment of the liquid transfer device according to the present invention, wherein FIG. 16A is a perspective view of the liquid transfer device and FIG. 16B is a section of the liquid transfer device shown in FIG. 16A;

FIG. 17 is an exploded perspective view of the liquid transfer device shown in FIGS. 16A and 16B;

FIG. 18A is a perspective view showing a construction of the first modification of the second embodiment of the liquid transfer device;

FIG. 18B is a cross section of the liquid transfer device shown in FIG. 18A;

FIG. 19 is an exploded perspective view of the liquid transfer device shown in FIGS. 18A and 18B;

FIGS. 20A to 20G are sections showing assembling process of the liquid transfer device shown in FIGS. 18A and 1SB;

FIG. 21A is a perspective view showing a construction of the first modification of the second embodiment of the liquid transfer device;

FIG. 21B is a cross section of the liquid transfer device shown in FIG. 21A;

FIG. 22 is an exploded perspective view of the liquid transfer device shown in FIGS. 21A and 21B;

FIGS. 23A to 23D are illustrations showing liquid transfer operation to be performed by the liquid transfer device shown in FIGS. 16A, 16B, 18A, 18B, 21A and 21B;

FIGS. 24A to 24C are diagrammatic illustrations for explaining view through conditions of the coloring agent depending upon variation of transmission coefficient of an absorbent in the first modification of the second embodiment;

FIGS. 25A and 25B are illustrations for explaining a liquid holding amount characteristics of the liquid holding member to be employed in the second embodiment of the liquid transfer device;

FIGS. 26A to 26D are perspective views showing assembling process in the third embodiment of the liquid transfer device according to the present invention;

FIG. 27 is a section of the liquid transfer device shown in FIGS. 26A to 26D;

FIG. 28 is a section showing the first modification of the third embodiment of the liquid transfer device according to the present invention;

FIGS. 29A to 29D are exploded perspective views showing assembling process of the liquid transfer device shown in FIG. 28;

FIGS. 30A to 30D are exploded perspective views showing assembling process of the fourth embodiment of the liquid transfer device according to the present invention;

FIG. 31A is a perspective view showing a shape of bottom surface of the liquid holding member in respective embodiment of the present invention;

FIGS. 31B and 31C are perspective views respectively showing a shape of the bottom surface of the liquid holding member in the fourth embodiment of the present invention, wherein FIG. 31B shows the bottom surface of the liquid holding member formed with a sectionally V-shaped groove, and FIG. 31C shows the bottom surface of the liquid holding member formed with a sectionally U-shaped groove;

FIGS. 32A and 32B are illustrations showing the fifth embodiment of the liquid transfer device according to the present invention, wherein FIG. 32A is a perspective view, and FIG. 32B are section;

FIG. 33 is an exploded perspective view of the liquid transfer device shown in FIGS. 32A and 32B;

FIG. 34 is a sectional view showing the sixth embodiment of the liquid transfer device according to the present invention;

FIG. 35 is a diagrammatic view to explain view conditions of a colored member in the liquid transfer device in FIG. 34;

Pig. 36 is a diagrammatic view to explain view conditions of a colored member in the liquid transfer device in FIG. 34;

FIG. 37 is a diagrammatic view to explain view conditions of a colored member in the liquid transfer device in FIG. 34; and

FIGS. 38A to 38D are perspective views showing manners of respective operations to perform transfer the liquid to the printed product greater than a transfer surface using the liquid transfer device shown in FIGS. 32A and 32B.

### DETAILED DESCRIPTION OF PREFERRED EMBODIMENTS

Preferred embodiments of the present invention will be discussed hereinafter in detail with reference to the drawings.

(Printed Product, Printing Medium and Protecting Liquid)

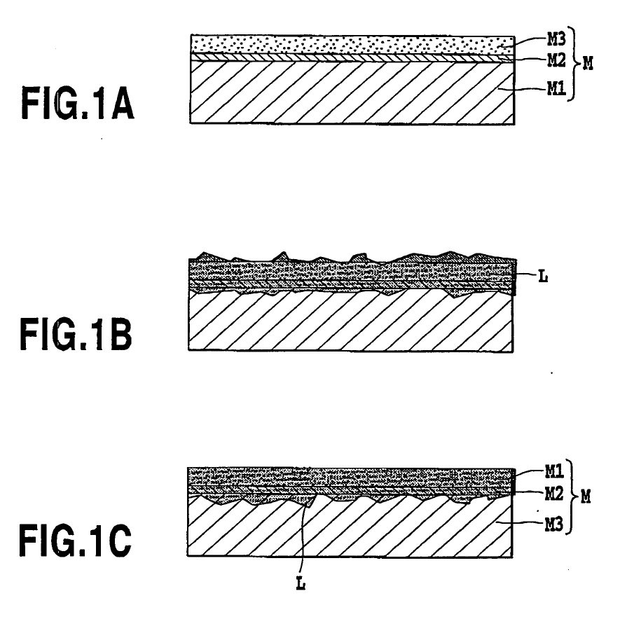

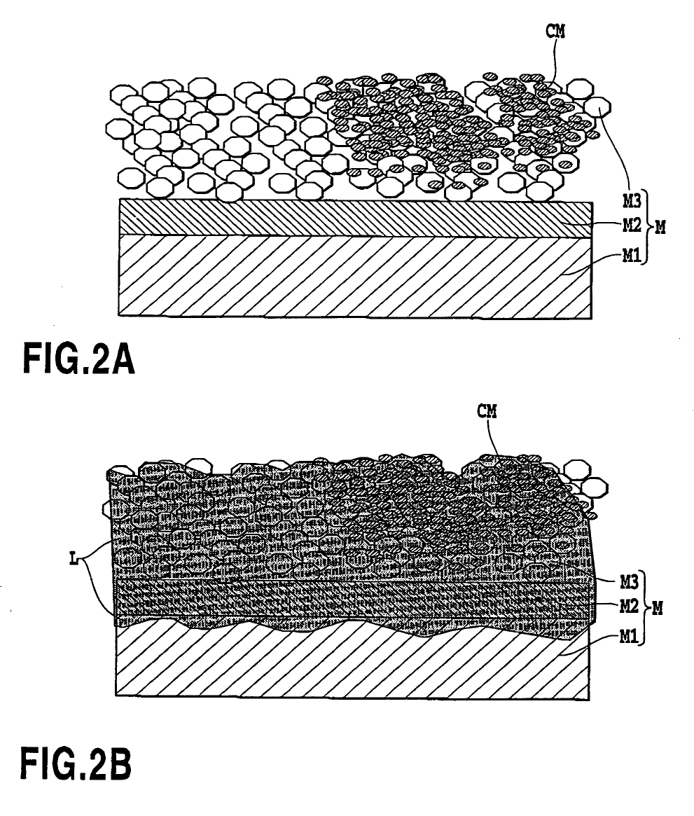

At first, discussion will be given for a printed product to be used in the present invention and a liquid (protecting liquid) to be transferred to the printed product with reference to FIGS. 1A to 2B. It should be noted that a word “transfer” used for description of the present invention includes print, impress or apply a liquid for protection on a surface of a printed product by contacting a printed product to be applied protecting treatment and a liquid transfer member of a liquid transfer device. On the other hand, in the present invention, a word “transfer zone (transfer surface)” represents either a surface per se of a porous member exemplified in the following embodiments or a surface of a desired impregnated member. Particularly, the member is an absorbent member of which a liquid impregnating amount is restricted by a restricting member including at least one layer of film, for restricting a transfer amount of liquid between the printed product to be protected and a liquid storage portion, and is an absorbent body, such as thin fibrous body (including paper) sponge or a laminated structural body or the like, which can absorb a necessary amount of liquid for one or more printed product for applying liquid thereon.

A “printed product” to be used in the present invention (the printed product applied the protecting treatment according to the present invention) is one formed with an image by applying inks containing coloring agents on a printing medium having a porous layer as an ink receptacle layer. Then, in the present invention, in such a printed product, liquid, such as silicon oils, fatty acid esters or the like is impregnated. Accordingly, it is desirable that the printing medium forming the printed product is those not causing so-called strike through. For example, it is preferably a printing medium which performs printing by at least absorbing coloring agents, such as dye, pigment or the like in fine particles forming a porous structure in an ink receptacle layer provided on a support body. The printing medium of such structure is particularly preferred for ink-jet printing.

Furthermore, such printing medium for ink-jet printing is preferably a so-called absorbent type which absorbs ink with void formed in the ink receptacle layer on the support body. The ink receptacle layer of absorbent type is primarily formed with fine particle and is formed into porous layer containing binder and/or other additive, as required.

As examples of fine particle, one or more kind selected among silica, clay, talc, calcium carbonate, porcelain clay, aluminum oxide, such as alumina, alumina hydrate or the like, diatom earth, titanium oxide, hydrotalcite, inorganic pigment such as zinc oxide or organic pigment, such as urea formalin resin, ethylene resin, styrene resin or the like, may be used.

Preferred binder to be used may be water soluble polymer or latex. For example, polyvinyl alcohol or modification thereof, starch or modification thereof, gelatin or modification thereof, gum Arabic, cellulose derivative, such as carboxymethyl cellulose, hydroxyethyl cellulose, hydroxypropylmethyl cellulose, SBR latex, NBR latex, methyl metacrylate-butadiene copolymer latex, functional group modified polymer latex, vinyl type polymer latex, such as ethylene-vinyl acetate copolymer, polyvinyl pyrrolidone, maleic anhydride and copolymer thereof, acryl ester copolymer may be used. These may be used as combination of two or more kinds as required. In addition, an additive may be used. For example, dispersing agent, thickening agent, pH adjuster, lubricant, fluidized modifying agent, surface active agent, anti-foaming agent, mold lubricant, fluorescent bleach, ultraviolet absorber, oxidant inhibitor and so on may be used.

Particularly preferred printing medium is those formed with the ink receptacle layer primarily consisted of fine particles having average particle size smaller than or equal to 10 μm, and more preferably smaller than or equal to 1 μm Particularly preferred fine particles are fine particles of silica or aluminum oxide or the like.

Preferred fine particles of silica are silica fine particles typified by colloidal silica. While colloidal silica per se is available from a market, particularly preferred is those disclosed in Japanese Patent No.2803134, Japanese Patent No. 2881847, for example.

Preferred fine particles of aluminum oxide may be fine particles of alumina hydrate. One of such alumina type pigment may be alumina hydrate expressed by the following formula:

Al₂O₃₋ₙ(OH)₂ₙ.MH₂O (1)

In the foregoing formula (1), n represents any one of integer of 1, 2 and 3, and m represents a value in a range of 0 to 10, and preferably 0 to 5. However, m and n cannot be 0 simultaneously. In many cases, mH₂O represents even desporptive water phase not to be involved with formation of mH₂O crystal grating. Therefore, m may be a value of integer or non-integer. Also, by heating this kind of material, m can reach the value of 0. As alumina hydrate, it is typically preferred those produced by hydrolysis of aluminum alcoxide or hydrolysis of sodium aluminate disclosed in U.S. Pat. No. 4,242,271 and U.S. Pat. No. 4,202,870, or by a method of adding an aqueous solution of sodium sulfate, aluminum chloride or the like to an aqueous solution of sodium aluminate as disclosed in Japanese Patent Application Publication No. 57-044605 (1982).

It should be noted that a reason why fine particles of aluminum oxide, silica or the like are particularly effective is as follow. Namely, it has been found that the coloring agent to be absorbed by fine particles of aluminum oxide or silica should cause significant tenebrescence of the coloring agent due to gases of NOₓ, SOₓ, ozone or the like. However, these particles can draw gases so that such gases may present in the vicinity of the coloring agent to easily cause tenebrescence of the coloring agent.

Furthermore, the printing medium for ink-jet printing using fine particles of aluminum oxide or fine particles of silica is superior in affinity, absorbability, fixing ability with protecting liquid, and can attain transparency, luster and fixing ability of the coloring agent in the printing liquid, such as dye or the like, as required for realizing photograph quality as set forth above. Therefore, such printing medium is optimal for use in the present invention. A mixture ratio of the fine particles and binder of the printing medium is preferably in a range of 1:1 to 100:1 by weight. By determining the amount of the binder in the foregoing amount, an optimal pore volume for impregnating the protecting liquid into the ink receptacle layer can be maintained. A preferred content of fine particles of aluminum oxide or fine particles of silica in the ink receptacle layer is greater than or equal to 50 Wt %, more preferably greater than or equal to 70 Wt %, further preferably greater than or equal to 80 Wt %, and most preferably smaller than or equal to 99 Wt %. A coating amount of the ink receptacle layer is preferably greater than or equal to 10 g/m² as converted into dried solid component in order to enhance impregnating ability of image fastness enhancing agent, and most preferably 10 to 30 g/m².

As the support (base paper) of the printing medium, there is no particular constraint, and any supports may be used as long as the ink receptacle layer containing the foregoing fine particles can be formed and having sufficient stiffness so as to be fed by a feeding mechanism of the ink-jet printer or the like. As the support, a sheet of paper provided with appropriate sizing at least on the surface to be formed the ink receptacle layer, one having high density porous layer (so called baryta layer) formed by coating inorganic pigment, such as barium sulfate or the like, and so on, on the fibrous support (such as baryta paper) may be preferably used. When such support is used, if the printed product provided with fastness enhancing treatment is left under high temperature and high humidity environment for a long period, it can quite effectively restrict the surface of the printed product to be sticky for exudation of the fastness enhancing agent, and can achieve storage stability. It should be noted that as a form of the printing medium having the porous layer on the surface, not only one formed with the porous ink receptacle layer on the support set forth above, but also anodized aluminum or the like may be used.

The liquid for protecting the printed product used in the present invention may be those not influencing the fixed image not dissolving the coloring agent deposited on the porous layer of the printing medium, being non-volatile, and protecting the coloring agent upon filling void in the porous layer for enhancing durability of the image. On the other hand, the liquid not adversely influencing for color tone of the image and being transparent and colorless capable of enhancing quality of the image, is superior in general applicability. However, in some occasion, colored liquid may also be used. Also, while the odorless liquid is superior in general applicability, it may also be possible to add some perfumery in a range not affecting to the image for discharging aroma matching with the image.

As the protecting liquid, for example, at least one selected among fatty acid ester such as pentaerythritol, silicon oil modified silicon fluorinated oil may be used. Particularly, for pore distribution and pore size of the printing medium, one dispersed and homogenized is preferred and entirely covering a presenting region (two-dimensional, three-dimensional) of the printed base material.

Such liquid for protecting image is held in a liquid transfer device according to the present invention, which will be discussed later. It is preferred that the liquid has an appropriate permeability into the porous layer, on which the coloring agent of the printed image is fixed. For example it is preferred that the liquid has viscosity in a range of about 10 to 400 cp (0.01 to 0.4 Pa·s). By using the liquid having such viscosity, irregularity in small application amount less than or equal to about 1 mm immediately after transfer (application) may be effectively homogenized using malleability by flow of the liquid.

FIGS. 1A to 1C show conditions where the liquid for protecting set forth above is applied to the printed product M having base paper (a support body) M1, a reflection layer M2 and the ink receptacle layer M3. FIG. 1A shows a condition before transferring the liquid, FIG. 1B shows a condition immediately after transfer of the liquid in which excessively transferred liquid is present on a surface of the printed product and optically recognized, and FIG. 1C shows a condition 2 to 5 minutes after transfer of the liquid in which the excessively transferred liquid is absorbed into the base paper M1.

FIGS. 2A and 2B are sections showing conditions before and after transfer of an appropriate amount of liquid on the printed product M by the liquid transfer device according to the present invention. For the printed product M in the condition where the coloring agent CM (dye in the embodiment herewith discussed) penetrates into the ink receptacle layer 3 shown in FIG. 2A, an appropriate amount of liquid L is applied as shown in FIG. 2B. Then, the liquid L is uniformly propagated over the entire ink receptacle layer M3 to certainly hold the coloring agent CM, and the extra amount of liquid may not overflow from the ink receptacle layer M3 to maintain in a condition not perceived even optically.

Here, results of transfer of the liquid for the printing medium having the ink receptacle layer having dimension and shape corresponding to one post card, are shown.

TABLE 1

| | Liquid | |
|---|---|---|
| Transfer | Absorbing | Condition of |
| Amount | Condition | Printing Surface |
| less than | Absorbable | Durability insufficient |
| 0.27 g | | |
| 0.33 g | Absorbable | Durability sufficient |
| 0.44 g | Absorbable if | Durability Sufficient |
| | left | |
| 0.40 g | Not absorbable | Durability sufficient and |
| or more | | image quality lowered |

Here, a transfer amount may be effected by density of a printed image or a drying time after printing. The above results are in the case of thoroughly dried states.

As can be appreciated from the results of the foregoing table 1, by realizing an appropriate amount of liquid transfer as set forth above, enhancement of an optical density OD can be observed and improvement of durability can be found. For the porous layer of the printed product fixed the coloring agent, necessary amount of the protecting liquid for filling void in the porous layer, to which the coloring agent is fixed, or slightly greater amount than the necessary amount is applied. However, if the liquid amount applied to the printed product significantly exceeds the foregoing necessary amount, a layer can be formed on the surface of the printed product by the excess amount of the liquid and whereby to cause degradation of image quality. For this reason, when a large amount of the liquid is applied to the surface of the printing medium, an operation for removing the excess amount of the liquid from the surface of the printed product becomes necessary. However, it is difficult to satisfactorily remove the liquid with maintaining necessary and sufficient light amount. Furthermore, due to botheration in deposition of the liquid on hand during operation, the operation for liquid removal is significantly troublesome. Furthermore, wasting liquid consuming amount becomes large to cause increasing of running cost.

In order to solve the problems set forth above, in the present invention, transfer of an appropriate amount of liquid is realized with the construction of preferred embodiments of the liquid transfer device which can transfer an appropriate amount of liquid to the printed product as a transfer object.

(First Embodiment)

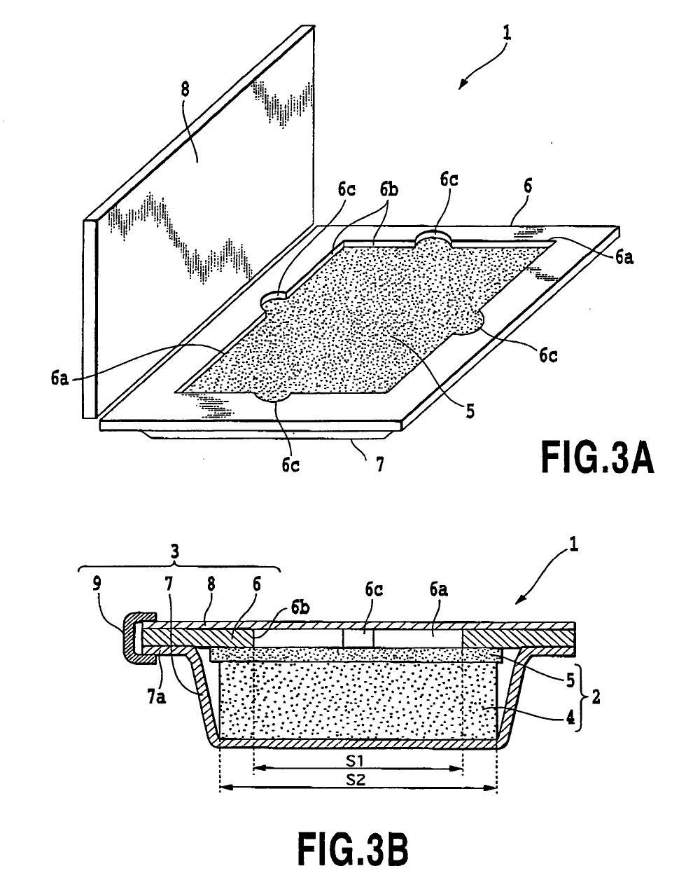

The first embodiment of a liquid transfer device according to the present invention will be discussed hereinafter with reference to FIGS. 3A to 5G.

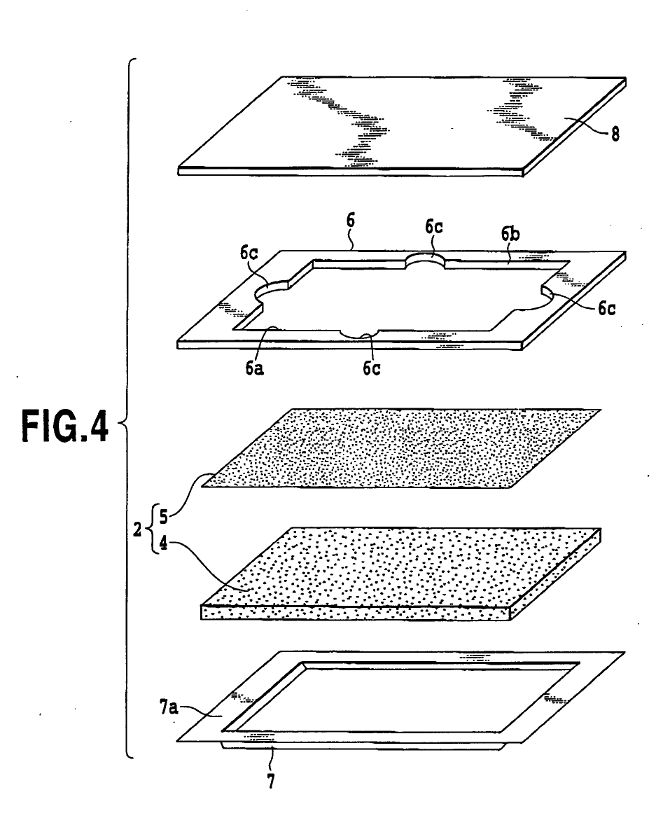

FIG. 3A is a perspective view showing a construction of the first embodiment of the liquid transfer device, and FIG. 3B is a section of the liquid transfer device shown in FIG. 3A, and FIG. 4 is an exploded perspective view of the liquid transfer device of FIG. 3A.

The first embodiment of the liquid transfer device 1 is constructed with a liquid transfer member 2 accumulating a liquid for enhancing durability of a printed product and transferring the liquid on a printed surface of the printed product, and a holding member 3 holding a circumference of the liquid transfer member 2.

The liquid transfer member 2 is constituted by a quadrangular sheet form liquid accumulating member (liquid accumulating portion) 4, which is formed from a fibrous body or a foamed sponge having a predetermined elasticity, and a quadrangular porous film 5 tightly fitted on one surface (front surface/outer surface side) of the liquid accumulating member 4 for covering the latter.

Here, the liquid accumulating member 4 has substantially uniform thickness, elasticity and density over the entire region and has a single layer structure. In this embodiment, a fibrous body is selected in consideration of shelf life. As a fibrous body, PP (polypropylene), PET (polyethylene terephthalate) or the like may be used. Here, PET having higher liquid holding ability is selected.

On the other hand, a density of the fibrous body determines large and small of liquid holding ability (capillary force) and elastic force depending upon high and low. Large and small of the liquid holding ability and elastic force determine large and small of discharge amount of the liquid contained therein and number of times of liquid to be transferred, as shown in table 2. Density of the fibers has to be appropriately selected depending upon number of times of transferring and exuding ability of the liquid and so forth. In the shown embodiment, assuming the printed product of the post card size, the fibrous body of the size 178 mm (longitudinal)×130 mm (lateral)×4.0 mm (thick), and practically applicable density of the fibrous body of this size is in a range of 0.06 g/cc to 0.4 g/cc. In the first embodiment, the density of the fibrous body is 0.2 g/cc.

On the other hand, the porous film 5 is formed from PTFE (polytetrafluoroethylene) film formed with pores permitting the liquid to pass, over the entire surface. In the case of the liquid having the foregoing viscosity 10 to 400 cp (centipoises; 0.01 to 0.4 Pa·s), it is desirable that pore size formed in the porous film 5 is in a range of 0.1 to 3 μm, preferably 0.1 to 1 μm, and thickness is 50 to 200 μm. It should be noted that when pore size of the porous film 5 is larger, liquid permeability becomes higher. Therefore, if the pore size becomes too large, exuding amount of the liquid to the surface of the porous film 5 from the liquid accumulating member 4 becomes excessive, and if the pore size becomes too small, exuding amount of the liquid to the surface side of the porous film 5 lacks. In an experiment, an optimal exuding amount could be obtained when the pore size of the porous film 5 is set at 0.2 μm.

Here, the pore size in this context means that used in the filter industry, and can be determined by means of test methods such as Bubble Point or Mean Flow Pore Test. Strictly speaking, results of these methods show different values respectively. However, they have similar tendencies and show almost same values. The value of the pore size shown in the present invention is measured by means of Bubble Point method.

On the other hand, making the thickness of the porous film 5 appropriate is important for avoiding occurrence of irregularity in transfer. Namely, when the porous film 5 is excessively thin, the porous film becomes less elastic to easily cause deformation to easily cause transfer irregularity upon transfer to the printing medium. Conversely, when the porous film is excessively thick, elasticity becomes excessively high to be hardly deformed to cause difficulty in flexibly contacting over the entire area upon transferring to the printing medium having bent or irregularity in shape. Even in this case, irregularity in transfer is easily caused. In the experiments, optimal transfer condition can be obtained without irregularity in transfer when the thickness of the porous film 5 is set at 80 μm.

It should be noted that a relationship of liquid holding ability of the porous film, the liquid accumulating member and the printed product is

printed product >porous film> liquid accumulating member.

On the other hand, the holding member 3 holding the foregoing liquid accumulating member 2 is constructed with a quadrangular surface supporting frame 6 bonded on the surface of the porous film 5 by an adhesive 60, a container form receptacle member 7 for receiving the liquid accumulating member 2, a lid 8 for covering an opening portion of the surface supporting frame 6 for opening and closing, and a connecting member 9 connecting the lid 8 and the receptacle member 7.

Amongst, the surface supporting frame 6 is formed with a plate member of PET having appropriate rigidity and thickness. The surface supporting frame 6 projects outwardly from the porous film 5, and is formed with a quadrangular opening portion 6a for exposing the porous film 5 housed inside of the surface supporting frame 6. It should be noted that thickness of the surf ace supporting frame 6 is set at 0.75 mm. On the other hand, the receptacle member 7 is formed into a container (dish) shape by vacuum molding of semi-transparent PET sheet having thickness of about 0.2 mm. A frame (flange) form connecting portion 7a projected along the opening portion is welded on the lower surface of the surface supporting frame. By this, the liquid transfer member 2 is received within a receptacle space defined by the receptacle member 7 and the surface supporting frame 6 in a condition impossible to dropout and exposing the surface of the liquid accumulating member 2 through the opening portion of the surface supporting frame 6. It should be noted that the reference numeral 6b shows an end face forming the opening portion 6a of the surface supporting frame 6, and the reference numeral 6c shows a recessed portion formed in each end face 6b for facilitating taking out of the printing medium inserted within the opening portion 6a.

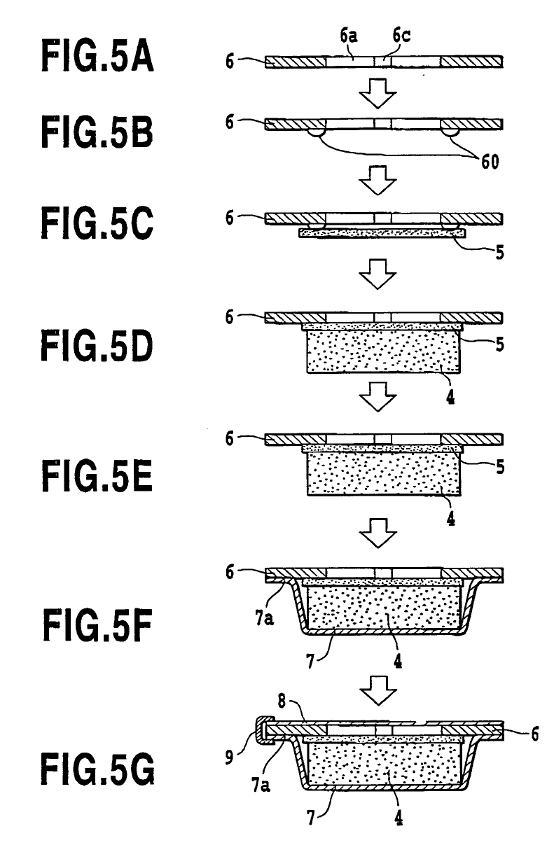

Here, a manufacturing process of the liquid transfer device constructed as set forth above, will be discussed with reference to FIG. 5. At first, the adhesive 60 is applied on a bottom surface of the surface support frame 6 along the opening portion 6a. With the adhesive 60, the surface supporting frame 6 is bonded on the surface of the porous film 5 (having dimension of 168 mm×126 mm×0.08 mm) (see FIGS. 5A. 5B and 5C). Next, the porous film 5 fixed on the surface supporting frame 6 is fitted on the surface of the liquid accumulating member (having dimension of 178 mm×130 mm×4.0 mm) 4. Then, these three members are housed within the receptacle member 7. Here, the bottom surface of the surface supporting frame 6 and a mating portion 7a of the receptacle member 7 are fitted and joined together by heat seal. At this timing, for a portion of the quadrangular mating portion 7a, a non-heat sealed portion is formed to serve as liquid pouring opening. A liquid supply tube connected to a predetermined liquid supply source is inserted into the liquid pouring opening to pour the liquid to the liquid accumulating member 4. Subsequently, the liquid supply tube is drawn out, and in place, a suction tube connected to a predetermined vacuum source is inserted to discharge inside air. At a timing reaching a given reduced pressure, the suction tube is drawn out to close the liquid pouring opening by heat seal.

Subsequently, the lid 8 is connected to the receptacle member 7 by the connecting member 9 which is welded on the lid 8 at one end and welded on the lower surface of the mating portion 7a of the receptacle member 7 at the other end (see FIG. 5G). Thus, manufacturing of the liquid transfer device is completed.

(First Modification of First Embodiment)

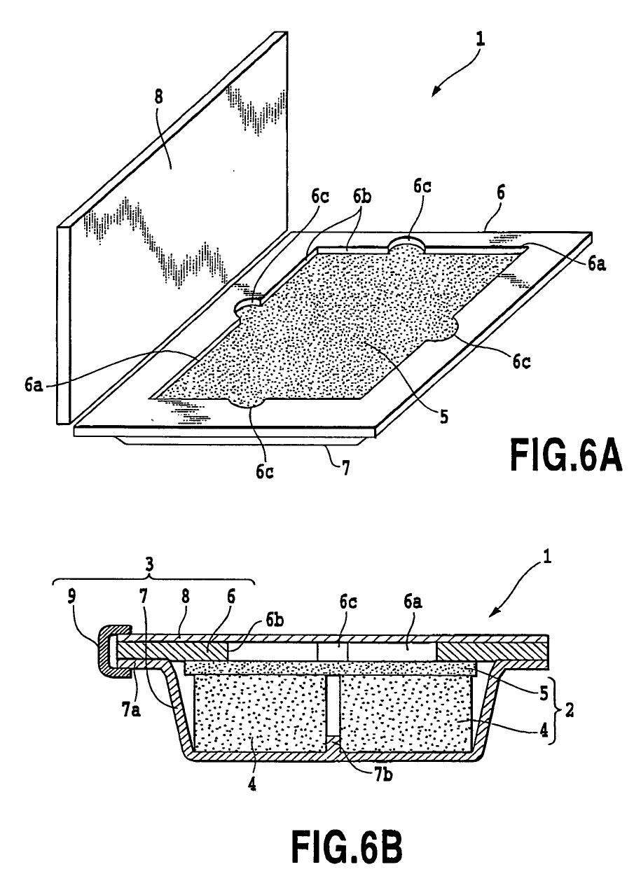

Hereinafter the first modification of the first embodiment of the liquid transfer device according to the present invention will be discussed with reference to FIGS. 6A to 8G.

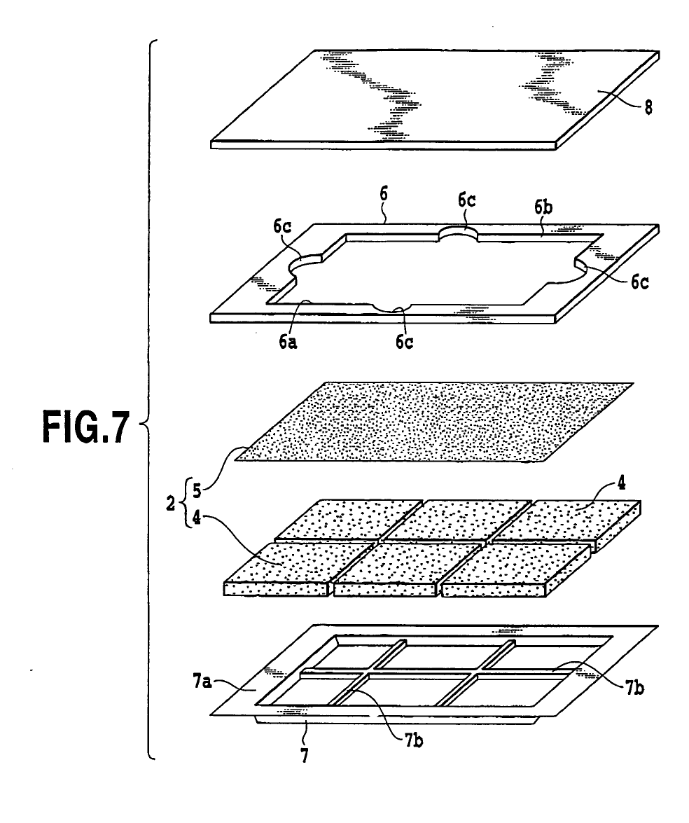

FIG. 6A is a perspective view showing a construction of the first modification of the first embodiment of the liquid transfer device, FIG. 6B is a cross section of the liquid transfer device shown in FIG. 6A, and FIG. 7 is an exploded perspective view of the liquid transfer device shown in FIGS. 6A and 6B.

The first modification of the first embodiment of the liquid transfer device 1 is constructed with the liquid transfer member 2 accumulating the liquid for enhancing durability of the printed product and transferring the liquid on the printed surface of the printed product, and the holding member 3 holding the circumferential edge of the liquid transfer member 2.

The liquid transfer member 2 is formed with a plurality of (six in the shown embodiment) quadrangular sheet form liquid accumulating members 4 formed from fibrous body or foamed sponge having predetermined elasticity, and the quadrangular porous film 5 tightly fitted and covering on one surf ace (front surface/outer surface side) of the liquid accumulating members 4.

Here, a plurality of liquid accumulating members 4 (also referred to as liquid holding members in the disclosure) have substantially equal thickness, elasticity and density with each other. In the shown embodiment of the present invention, by using a plurality of separated liquid accumulating members 4 with integral porous film 5, it becomes possible to hold the liquid with uniformly distributing the liquid over entire area of the porous film 5 which will be discussed later in detail. Particularly, irrespective of an attitude of the liquid transfer device 1 before transfer, uniform distribution of the liquid becomes possible. Then, by uniform distribution, the liquid may be supplied uniformly over the entire area of the printed region upon transferring the liquid to the printed product through the porous film 5.

The first modification of the shown embodiment of the liquid accumulating member 4 is formed by selecting fibrous body in consideration of shelf life. As the fibrous body, PP (polypropylene), PET (polyethylenterephthalate) and the like is applicable. Here, PET having more superior foil holding force is selected. On the other hand, a density of the fibrous body determines large and small of liquid holding ability (capillary force) and elastic force depending upon high and low. Large and small of the liquid holding ability and elastic force determine large and small of discharge amount of the liquid contained therein and number of times of liquid transfer, as shown in table 2. Density of the fibers has to be appropriately selected depending upon number of times of transferring and exuding ability of the liquid and so forth. In the shown embodiment, assuming the printed product of the post card size, the fibrous body of the size 178 mm (longitudinal)×130 mm (lateral)×4.0 mm (thick), and practically applicable density of the fibrous body of this size is in a range of 0.06 g/cc to 0.4 g/cc. In the first embodiment, the density of the fibrous body is 0.2 g/cc.

On the other hand, the porous film 5 is formed from PTFE (polytetrafluoroethylene) film formed with pores permitting the liquid to pass, over the entire surface. In the case of the liquid having the foregoing viscosity 10 to 400 cp (centipoises; 0.01 to 0.4 Pa·s), it is desirable that pore size formed in the porous film 5 is in a range of 0.1 to 3 μm preferably 0.1 to 1 μm, and thickness is 50 to 200 μm. It should be noted that when pore size of the porous film 5 is larger, liquid permeability becomes higher. Therefore, if the pore size becomes too large, exuding amount of the liquid to the surface of the porous film 5 from the liquid accumulating member 4 becomes excessive, and if the pore size becomes too small, exuding amount of the liquid to the surface side of the porous film 5 lacks. In an experiment, an optimal exuding amount could be obtained when the pore side of the porous film 5 is set at 0.2 μm.

Here, the pore size in this context means that used in the filter industry, and can be determined by means of test methods such as Bubble Point or Mean Flow Pore Test. Strictly speaking, results of these methods show different values respectively. However, they have similar tendencies and show almost same values. The value of the pore size shown in the present invention is measured by means of Bubble Point method.

On the other hand, making the thickness of the porous film 5 appropriate is important for avoiding occurrence of irregularity in transfer. Namely, when the porous film 5 is excessively thin, the porous film becomes less elastic to easily cause deformation to easily cause transfer irregularity upon transfer to the printing medium. Conversely, when the porous film is excessively thick, elasticity becomes excessively high to be hardly deformed to cause difficulty in flexibly contacting over the entire area upon transferring to the printing medium having bent or irregularity in shape. Even in this case, irregularity in transfer is easily caused. In the experiments, an optimal transfer condition can be obtained without irregularity in transfer when the thickness of the porous film 5 is set at 80 μm.

It should be noted that a relationship of liquid holding ability of the porous film, the liquid accumulating member and the printed product is, taking the exuding ability or the like into consideration,

printed product >porous film> liquid accumulating member.

On the other hand, the holding member 3 holding the foregoing liquid accumulating member 2 is constructed with a quadrangular surface supporting frame 6 bonded on the surface of the porous film 5 by an adhesive 60, a container form receptacle member 7 for receiving the liquid accumulating member 2, a lid 8 for closing an opening portion of the surface supporting frame 6 for opening and closing, and a connecting member 9 connecting the lid 8 and the receptacle member 7.

Amongst, the surface supporting frame 6 is formed with the plate member of PET having appropriate rigidity and thickness, projecting outwardly from the porous film 5, and is formed with a quadrangular opening portion 6a for exposing the porous film 6 housed inside of the surface supporting frame 6. It should be noted that thickness of the surface supporting frame 6 is set at 0.75 mm.

The receptacle member 7 is formed into a container shape by vacuum molding of semi-transparent PET sheet having thickness of about 0.2 mm A frame form connecting portion 7a projected along the opening portion is welded on the lower surface of the surface supporting frame 6. By this, the liquid transfer member 2 is received within a receptacle space defined by the receptacle member 7 and the surface supporting frame 6 in a condition impossible to dropout and exposing the surface of the liquid accumulating member 2 through the opening portion of the surface supporting frame 6. It should be noted that the reference numeral 6b denotes an end face forming the opening portion 6a of the surf ace supporting frame 6, and the reference numeral 6c denotes a recessed portion formed in each end face 6b for facilitating taking out of the printing medium inserted within the opening portion 6a.

In the receptacle member 7, a plurality of foregoing liquid accumulating members 4 are provided in a separated manner. Corresponding to this, partitioning walls 7b defining a plurality of receptacle chambers for receiving respective liquid accumulating members 4 are provided. A thickness of each partitioning wall 7b is 0.5 mm and height thereof is 1.5 mm. As discussed later in connection with FIG. 7, by appropriately determining the size of the partitioning walls 7, respective liquid accumulating members 4 housed separately in the receptacle chambers can maintain an appropriate interval. By this, in a condition not transferring the liquid, the liquid held in each liquid accumulating members 4 are not communicated with each other. On the other hand, upon transferring, the liquid held in respective liquid accumulating members 4 are communicated with each other so that the liquid can be exuded uniformly over the entire porous film 5 without forming non-exuding portion despite of presence of gaps defined between respective liquid accumulating members received separately. As a result, it can prevent occurrence of irregularity in liquid transfer to the printed product due to failure of dispersion of the liquid over the surface of the porous film 5 upon transferring.

On the other hand, considering thickness of the partitioning walls 7b, finishing accuracy of the liquid accumulating members is determined. Namely, when burr formed upon formation of the liquid accumulating members by processing the fibrous body, extends over the space between the liquid accumulating members to cause communication of the separated liquid accumulating members, such burr may cause communication of liquid even in non-transferring state and thereby possibly cause local concentration of the liquid. Therefore, particularly depending upon the thickness of the partitioning wall 7b determined so that the liquid does not communicate during non-transferring state and the liquid is communicated by depression via the porous film or transfer film upon transferring, the finishing accuracy is determined so that a length of burr is less than or equal to the thickness of the partitioning wall even though burr is produced.

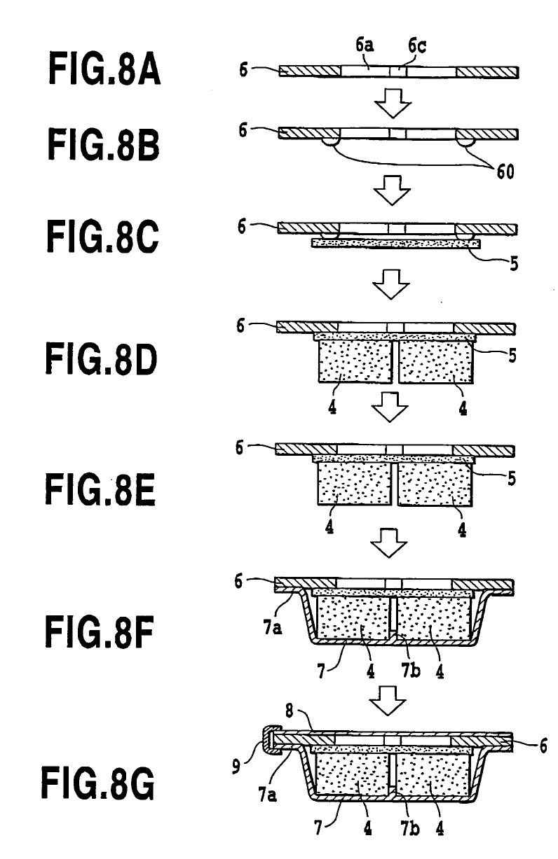

Next, manufacturing process of the liquid transfer device having the construction set forth above will be discussed with reference to FIG. 8. At first, the adhesive 60 is applied on a portion of the bottom surface of the surface support frame 6 around the opening portion. With the adhesive 60, the surface supporting frame 6 is bonded on the surface of the porous film 5 (having dimension of 168 mm×126 mm×0.08 mm) (see FIGS. 8A, 8B and 8C). Next, the porous film 5 fixed on the surface supporting frame 6 is fitted on the surface of the separated liquid accumulating member (each having dimension of one sixth of 178 mm×130 mm×4.0 mm) 4. Then, these three members are housed within respective receptacle chambers defined by the partitioning walls 7b in the receptacle member 7.

Here, the bottom surface of the surface supporting frame 6 and a mating portion 7a of the receptacle member 7 are fitted and joined together by heat seal. Thereafter, for the surface of the porous film 5, the liquid is supplied from the liquid supply tube connected to the predetermined liquid supply source. By this, supplied liquid penetrates into respective liquid accumulating members via the porous film 5 and held therein. A method for filling the liquid in the liquid accumulating members 4 is no limited to the method of the foregoing example. For example, before contacting the porous film 5 onto respective liquid accumulating member 4, the liquid may be directly filled in respective liquid accumulating members 4.

Subsequently, the lid 8 is connected to the receptacle member 7 by the connecting member 9 a which is welded on one edge of the lid 8 and welded on the lower surface of the mating portion 7a of the receptacle member 7 (see FIG. 8G). Thus, manufacturing of the liquid transfer device is completed.

(Second Modification of First Embodiment)

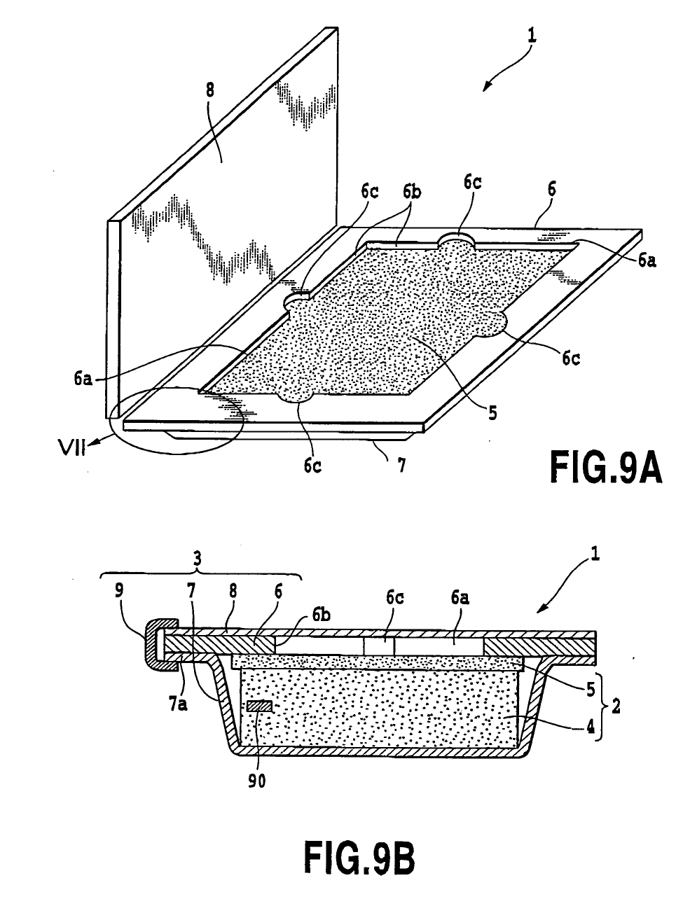

Hereinafter the second modification of the first embodiment of the liquid transfer device according to the present invention will be discussed with reference to FIGS. 9A to 11G.

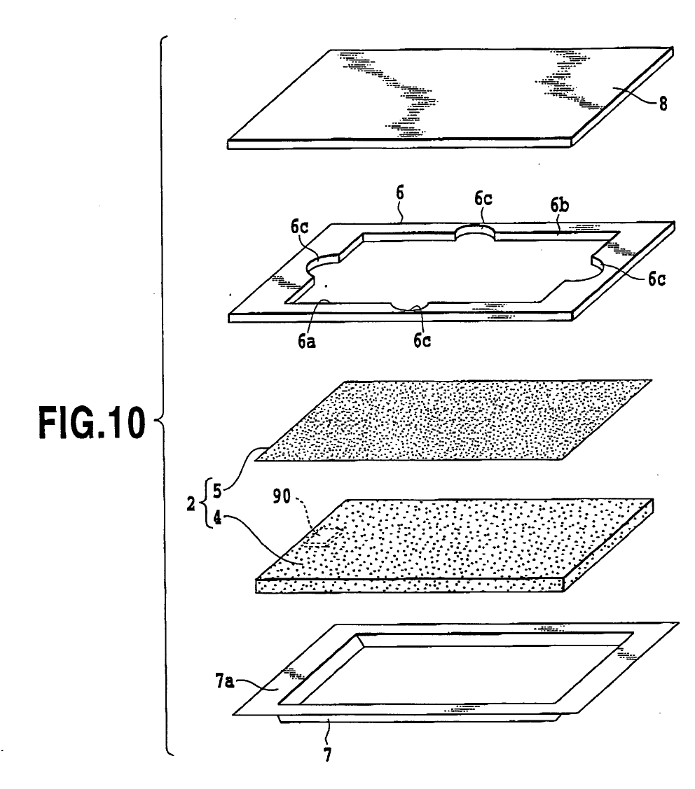

FIG. 9A is a perspective view showing a construction of the second modification of the first embodiment of the liquid transfer device, FIG. 9B is a cross section of the liquid transfer device shown in FIG. 9A, and FIG. 10 is an exploded perspective view of the liquid transfer device shown in FIGS. 9A and 9B.

The liquid transfer device 1 illustrated in FIGS. 9A to 11G is constructed with the liquid transfer member 2 accumulating a liquid for enhancing durability of a printed product and transferring the liquid on the printed surface of the printed product, and the holding member 3 holding a circumferential edge of the liquid transfer member 2. The liquid transfer member 2 is formed with a quadrangular sheet form liquid accumulating member (absorbent body) 4 formed from a fibrous body or a foamed sponge having a predetermined elasticity, and a quadrangular porous film (porous body) 5 tightly fitted on one surface (front surface/outer surface side) of the liquid accumulating member for covering the latter.

The liquid accumulating member 4 has substantially uniform thickness, elasticity and density over the entire region and has a single layer structure. In this embodiment, a fibrous body is selected as the liquid accumulating member 4 in consideration of shelf life. As fibrous body, PP (polypropylene), PET (polyethyleneterephthalate) or the like may be used. Here, PET having higher superior foil holding ability is selected.

On the other hand, a density of the fibrous body determines large and small of liquid holding ability (capillary force) and elastic force depending upon high and low. Large and small of the liquid holding ability and elastic force determine large and-small of discharge amount of the liquid contained therein and number of times of liquid transfer, as shown in table 2. Density of the fibers has to be appropriately selected depending upon number of times of transferring and exuding ability of the liquid and so forth. In the shown embodiment, assuming the printed product of the post card size, the fibrous body of the size 178 mm (longitudinal)×130 mm (lateral)×4.0 mm (thick) and practically applicable density of the fibrous body of this size is in a range of 0.06 g/cc to 0.4 g/cc. In the first embodiment, the density of the fibrous body is 0.2 g/cc.

On the other hand, the porous film 5 is formed from PTFE film formed with pores permitting the liquid to pass, over the entire surface. In case of the liquid having the foregoing viscosity 10 to 400 cp (0.01 to 0.4 Pa·s), it is desirable that pore size formed in the porous film 5 is in a range of 0.1 to 3 μm, preferably 0.1 to 1 μm, and thickness is 50 to 200 μm. It should be noted that when pore size of the porous film 5 is larger, liquid permeability becomes higher. Therefore, if the pore size becomes too large, exuding amount of the liquid to the surface of the porous film 5 from the liquid accumulating member 4 becomes excessive, and if the pore size becomes too small, exuding amount of the liquid to the surface side of the porous film 5 becomes too small. In an experiment, an optimal exuding amount could be obtained when the pore size of the porous film 5 is set at 0.2 μm.

Here, the pore size in this context means that used in the filter industry, and can be determined by means of test methods such as Bubble Point or Mean Flow Pore Test. Strictly speaking, results of these methods show different values respectively. However, they have similar tendencies and show almost same values. The value of the pore size shown in the present invention is measured by means of Bubble Point method.

On the other hand, making the thickness of the porous film 5 appropriate is important for avoiding occurrence of irregularity in transfer. Namely, when the porous film 5 is excessively thin, the porous film becomes less elastic to easily cause deformation to easily cause transfer irregularity upon transfer to the printing medium. Conversely, when the porous film is excessively thick, elasticity becomes excessively high to be hardly deformed to cause difficulty in flexibly contacting over the entire area upon transferring to the printing medium having bent or irregularity in shape. Even in this case, irregularity in transfer is easily caused. In the experiments, optimal transfer condition can be obtained without irregularity in transfer when the thickness of the porous film 5 is set at 80 μm. It should be noted that a relationship of liquid holding ability of the porous film 5, the liquid accumulating member 4 and the printed product is

printed product >porous film> liquid accumulating member.

In the second modification, a colored member (remaining amount detecting body) 90 for monitoring remaining amount of the liquid is embedded in the liquid accumulating member 4, as shown in FIG. 9. The colored member 90 is buried in the liquid accumulating member 4 by forming cut line in the latter. The colored member 90 is formed from a polypropylene mesh sheet, a sheet formed with apertures, a sheet with slits and so on, colored into a predetermined color, for example. In the shown embodiment, the coloring agent has external dimension of 15 mm in a longitudinal direction, 5 mm in a lateral direction and 0.2 mm of thickness. As set forth above, by forming the colored member 90 to have at least 5 mm×5 mm of external dimension, visibility of the colored member 90 can be ensured with avoiding the presence thereof to serve as hindrance for flow of the liquid in the liquid accumulating member 4. On the other hand, by forming the colored member 90 from a thin sheet having a plurality of apertures permitting flow of the liquid, presence of the colored member 90 does not interfere flow of the liquid in the liquid accumulating member 4. It should be noted that, in the shown embodiment, as a color to be provided for the colored member 90, green is selected. However, the color of the colored member 90 can be selected arbitrary as long as visibility can be ensured.

On the other hand, the holding member 3 holding the foregoing liquid accumulating member 2 is constructed with the quadrangular surface supporting frame 6 bonded on the surface of the porous films by an adhesive 60, the receptacle member (support) 7 serving as a container for receiving the liquid accumulating member 2, a lid 8 for covering an opening portion of the surface supporting frame 6 for opening and closing, and a connecting member 9 connecting the lid 8 and the receptacle member 7.

The surface supporting frame 6 is formed from the plate member of PET having an appropriate rigidity and thickness, projecting outwardly from the porous film 5, and is formed with a quadrangular opening portion 6a for exposing the porous film 6 housed therein. It should be noted that thickness of the surface supporting frame 6 is set at 0.75 mm in the shown embodiment. On the other hand, the receptacle member 7 is formed into a container shape by vacuum molding of substantially transparent (semi-transparent) PET sheet having thickness of about 0.2 mm. A frame (flange) form connecting portion 7 projected along the opening portion is welded on the lower surface of the surface supporting frame. By this, the liquid transfer member 2 is received within a receptacle space defined by the receptacle member 7 and the surface supporting frame 6 in a condition impossible to dropout and exposing the surface of the liquid accumulating member 2 through the opening portion of the surface supporting frame 6. It should be noted that the reference numeral 6b denotes the end face forming the opening portion 6a of the surface supporting frame 6, and the reference numeral 6c denotes a recessed portion formed in each end face 6b for facilitating taking out of the printing medium inserted within the opening portion 6a.

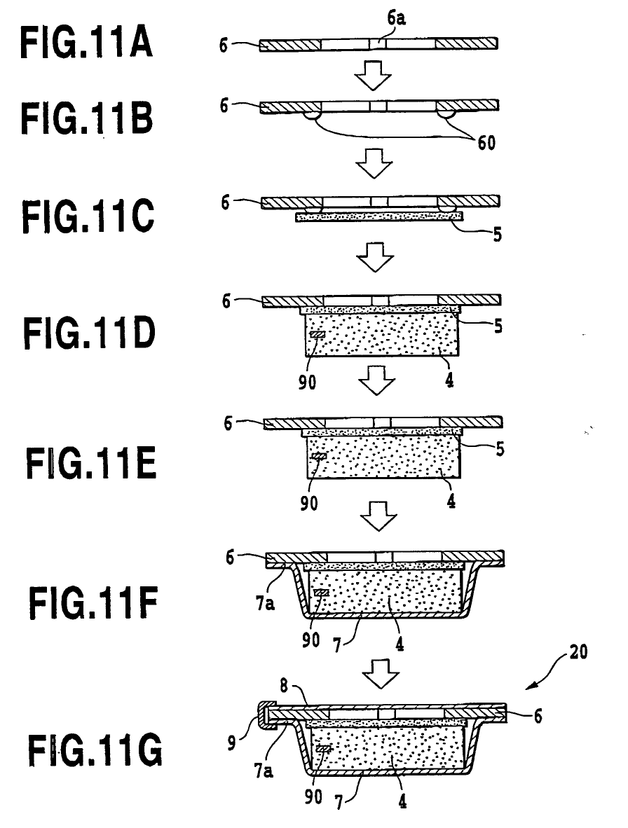

Here, a manufacturing process of the liquid transfer device constructed as set forth above, will be discussed with reference to FIG. 11. At first, the adhesive 60 is applied on the bottom surface of the surface support frame 6 along the opening portion 6a. With the adhesive 60, the surface supporting frame 6 is bonded on the surface of the porous film 5 (having dimension of 168 mm×126 mm×0.08 mm) (see FIGS. 11A, 11B and 11C). Next, the porous film 5 fixed on the surface supporting frame 6 is fitted on the surface of the liquid accumulating member (having dimension of 178 mm×130 mm×4.0 mm) 4 with the embedded colored member 90 Then, these three members are housed within the receptacle member 7. Here, the bottom surface of the surface supporting frame 6 and a mating portion 7a of the receptacle member 7 are fitted and joined together by heat seal. At this timing, for a portion of the quadrangular mating portion 7a, a non-heat sealed portion is formed to serve as liquid pouring opening.

A liquid supply tube connected to a predetermined liquid supply source is inserted into the liquid pouring opening to pour the liquid to the liquid accumulating member 4. Subsequently, the liquid supply tube is drawn out from the liquid pouring opening, and in place, the suction tube connected to a predetermined vacuum source is inserted to discharge inside air. At a timing reaching a given reduced pressure, the suction tube is drawn out from the liquid pouring opening to close the liquid pouring opening by heat seal. Subsequently, the lid 8 is connected to the receptacle member 7 by the connecting sheet which is welded to of the lid 8 at one end and welded on the lower surface of the mating portion 7a of the receptacle member 7 at the other end (see FIG. 1G). Thus, manufacturing of the liquid transfer device 1 is completed.

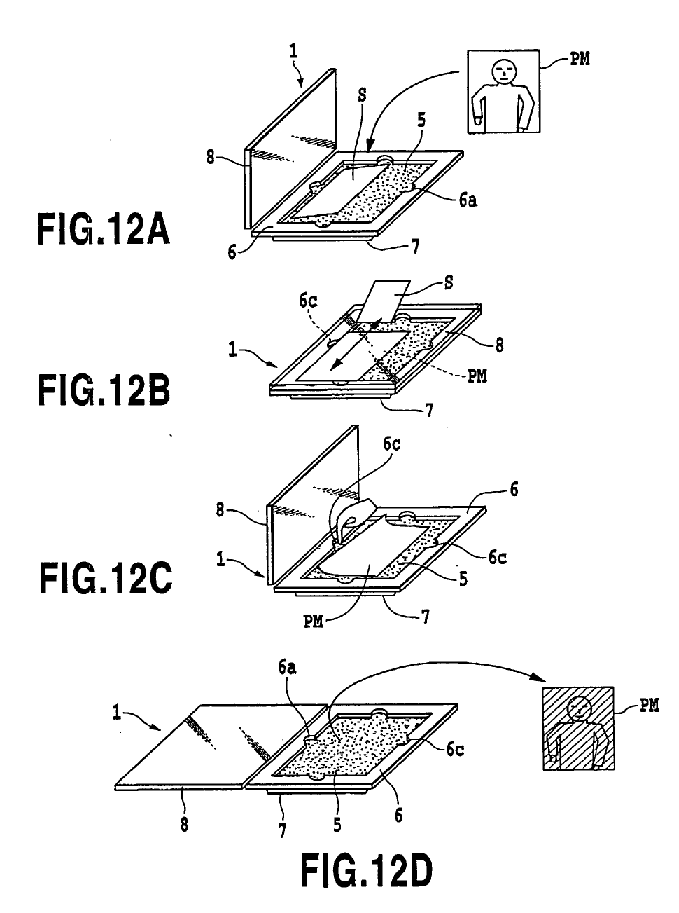

Next, procedure of transferring of the liquid on the printed product using the liquid transfer device will be discussed with reference to FIGS. 12A to 12D.

At first, the printed product to which is applied ink in the ink receptacle layer by an ink-jet printing apparatus or the like, is prepared. Here, it is desired that the printed product is in a condition where solvent and moisture content contained in the ink is sufficiently evaporated. It has been confirmed that the solvent and moisture content in the liquid are completely evaporated from the ink receptacle layer after about thirty minutes from completion of printing, in normal case.

On the other hand, in the liquid transfer device 1, the liquid accumulated in the liquid accumulating member 4 is drawn toward inside of the pores by the porous film 5 having greater liquid holding ability (capillary force) than the liquid accumulating member 4. Upon initiation of transfer, the lid 8 is opened to mount the printed product on the surface (transfer zone) of the porous film 5 exposed from the opening portion 6a of the surface supporting frame 6 in a condition where the surface of the porous film 5 and the printed surface are contacted (see FIG. 12A), subsequently, the lid 8 is closed to cover the printed product PM. A pallet S is urged onto the lid 8 and reciprocally moved for several times to tightly fitting the printed surface of the printing product PM and the porous film 5 (see FIG. 12B).

By a depression force from the pallet S, the liquid accumulating member 4 is elastically deformed downwardly. Then, by this elastic deformation, the liquid accumulated therein is pushed out toward the surface side (printed product side). On the other hand, between the liquid accumulating member 4 and the printed surface (ink receptacle layer) of the printed product PM, the porous film 5 is present. The liquid flow toward the printing medium pushed out from the liquid accumulating member 4 is restricted by the porous film 5 so that the liquid is transferred to the printing product in just proportion. In the shown embodiment, the liquid accumulating member 4 has elasticity and the porous film 5 has flexibility. Therefore, when bending or irregularity of shape are present in the printed product PM, the entire surface of the porous film 5 is flexibly follows the surface of the printed product PM. Thus, the liquid is uniformly transferred over the entire printed surface of the printed product PM.

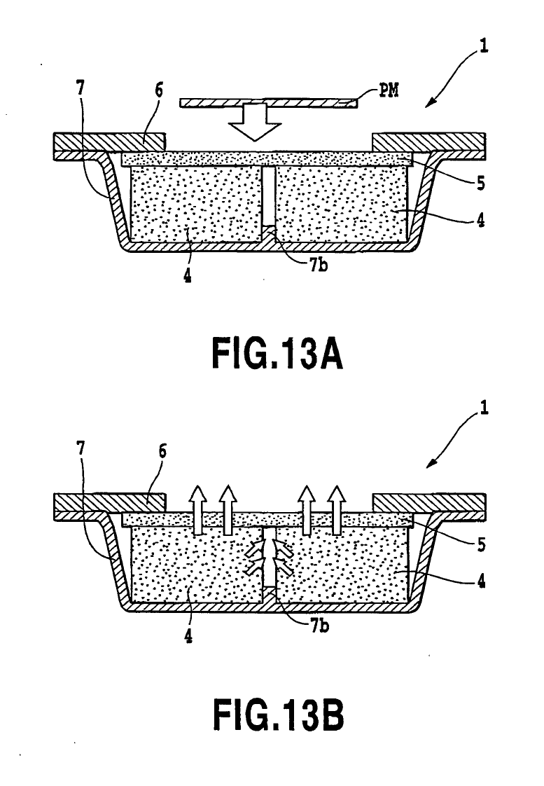

In the first modification of the first embodiment, a manner to push out the liquid in the liquid accumulating member 4 toward the surface side (printed product side) by elastic deformation when the liquid accumulating member 4 is elastically deformed downwardly by a depression force from the pallet S, will be discussed with reference to FIGS. 13A and 13B.

When the printed product PM is mounted on the porous film 5 and is depressed by the pallet S in a scuffing manner as shown in FIG. 13A, the liquid accumulating members 4 are depressed as shown in FIG. 13B to push out the liquid held in the liquid accumulating members 4 to be exuded upwardly, namely to the surface of the porous film 5. At the same time, the liquid is also exuded into the space above the partitioning walls 7b between the liquid accumulating members 4 to fill. Then, the liquid filling the space is also exuded to the surface of the porous film 5. As set forth above, the liquid held in each liquid accumulating members 4 without communicating with that in the adjacent liquid accumulating members 4 in non-transferring state, is exuded upon transfer to fill the gaps between the liquid accumulating members 4 so as to form continuous liquid film on the surface of the porous film 5 without discontinuity. It should be noted that appropriate deformation of the liquid accumulating members 4 is required when depressed by means of the pallet S in order to form the continuous liquid film on the surface of the porous film 5. Therefore, it is desirable that the receptacle member 7 holding the liquid accumulating members 4 may have a stiffness greater than or equal to a given value.

When the liquid is exuded as set forth above, the porous film 5 is present between the liquid accumulating member 4 and the printed surface (ink receptacle layer) of the printed product PM, and the porous film 5 restricts flow out of the liquid pushed out from the liquid accumulating member 4 so that the liquid may be transferred to the printed product just in proportion. Furthermore, since elasticity is provided for the liquid accumulating members 4 and flexibility is provided for the porous film 5, even if bending or irregularity of shape are present in the printed product PM, the entire surface of the porous film 5 is flexibly follows the surface of the printed product PM. Thus, the liquid is uniformly transferred over the entire printed surface of the printed product PM.

It should be appreciated that, when the liquid accumulating member 4 are directly contacted with the printed product without providing the porous film 5 not as in the first embodiment, large amount of liquid pushed out from the liquid accumulating member 4 can be transferred to the printed product to possibly require wiping.

As set forth above, after sufficiently contacting the printed product PM on the porous film 5, the printing medium is removed from the porous film 5. The printed product PM is tightly fitted on the surface of the porous film 5 and stuck thereon by viscosity of the liquid. Therefore, upon removal from the surface of the porous film 5, a finger is hooked at an end portion of the printed product PM to peel off from the end (FIG. 12C). At this time, even when little gap is present between the surface support frame 6 and the printed product, the finger may be inserted through the recessed portion 6c of the surface supporting frame 6 to easily hook the finger to the end edge of the printed product PM, permiting smooth removal of the printed product PM without causing injury of the transfer surface (see FIG. 12D).

Here, in the first embodiment, a result of experiments checking relationship between number of times of appropriate transfer (transferable number), the condition of the liquid exuded from the liquid accumulating member 4 in the initial condition immediately after completion of the liquid supply for the liquid accumulating member 4, and liquid holding ability of the liquid accumulating member, is shown in the following table 2.

TABLE 2

| | | | Initial | Liquid |
|---|---|---|---|---|
| Density | Transferable | | Exuding | Holding |
| (g/cc) | Number | | Amount | Ability |
| 0.4 | 20 to 30 | times | Appropriate | Sufficient |
| 0.2 | 30 to 50 | times | Appropriate | Sufficient |
| 0.1 | 30 to 70 | times | Excessive | Sufficient |
| 0.06 | 100 | times | Excessive | Insufficient |

As can be clear from the table 2, higher density of the liquid accumulating member 4 results in higher stiffness to increase difficulty in causing elastic deformation (difficult to squeeze) to make a liquid holding ability by a capillary force higher. Accordingly, an exuding liquid amount is decreased according to increasing of density of the liquid accumulating member. On the other hand, lowering of the density of the liquid accumulating member makes easier to cause elastic deformation (easier to squeeze) to lower the liquid holding ability to increase the exuding liquid amount upon transfer. By this experiments, when the density of the liquid accumulating member is less than or equal to 0.1 g/cc, the initial exuding amount became excessive. On the other hand, when the density of the liquid accumulating member is less than or equal to 0.06 g/cc, transferable number becomes more than or equal to hundred times. However, a sufficient liquid holding ability (capillary force) cannot be obtained to make the initial liquid exuding amount excessively large. If the liquid transfer device is tilted even slightly, the liquid flows downwardly to cause local concentration to make uniform liquid supply impossible. Therefore, in the shown embodiment, density of the liquid accumulating member is set at 0.2 g/cc.

(Test for Printed Product after Liquid Transfer)

Furthermore, for the printed product transferred liquid by the first embodiment of the liquid transfer device 1, a measurement test of image density and an accelerated life test were performed.

In this tests, the printed product on which a photographic image was printed on a printing medium having an ink receptacle layer of pseudoboehmite using an ink-jet printer BJF870 by Canon Inc. as an ink-jet printer, was used. As a printing medium, one prepared by providing a reflection layer (about 15 μm thick layer of BaSO₄) and a 30 μm thick ink receptacle layer formed of pseudoboehmite alumina, was used. On the printing medium set forth above, printing was performed using an ink containing dye type coloring agents by the printer set forth above to obtain a printed product carrying the printed image by absorbing coloring agents in the ink receptacle layer containing alumina. In the ink receptacle layer after printing, void to absorb the liquid was remained.

On the other hand, as an image protecting liquid, transparent and odorless fatty acid ester (tri-iso-stearic acid trimethylol propane expressed by the following formula, viscosity: 200 Cassette) removed unsaturated component causing yellow-tinging and odor, was used among fat and oils to transfer over the entire printed surface of the printed product by the liquid transfer device 1.

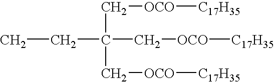

It should be noted that respective tests were performed under the following conditions.

(1) Image Density Measuring Test

The image density was measured by a reflection type photometer RD-918 (tradename) available from MacBeth Corporation. Measured image density was expressed by OD of black portion of the image.

(2) Accelerated Life Test

Using Ozone Weather Meter (tradename) available from Suga Tester Kabushiki Kaisha, image density value (OD value) was measured after exposure process of two hours under atmosphere of 3 ppm of ozone to derive variation rate of OD before and after exposure (ΔE={[OD after exposure−OD before exposure]/[OD before exposure]}×100) for evaluation of light fastness.

(3) Result

For comparison with the first embodiment, ΔE value in silver halide photograph was measured. The value was about 0.2. In contrast to this, ΔE value obtained by the first embodiment was 0.2. The image transferred the liquid by the first embodiment of the liquid transfer device 1 is predicted to have comparable durability as silver halide photograph under exposure to atmosphere. This indicates that the silver halide photograph causes discoloration under exposure to atmosphere in two to several tens years, and the image provided protection treatment by the first embodiment of the liquid transfer device 1 can enjoy the initial image quality over the comparable period as the silver halide photograph.

As set forth above, by providing the foregoing protection treatment by the shown embodiment of the liquid transfer device 1, the raw image can be enjoyed over a long period without presence of the protecting member, such as glass or film.

(Construction of Liquid Accumulating Member in First Embodiment)

Next, discussion will be given for preferred number of division, dimension, shape or the like of the liquid accumulating member applied to the first embodiment.

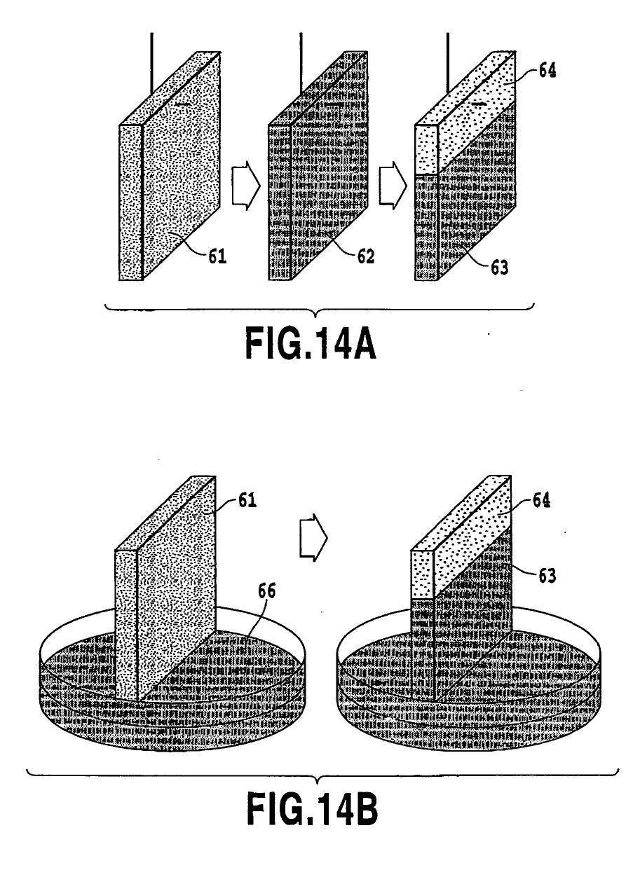

FIGS. 14A and 14B are illustrations for discussing about characteristics of the shown embodiment of the liquid accumulating member 4.

A liquid amount to be held by the liquid holding member, such as fibrous body, forming the liquid accumulating member 4 is basically depending upon water head by capillary force. Accordingly, in the case of the liquid holding member having a given shape, the liquid amount to be held may be differentiated depending upon the attitude thereof. FIGS. 14A and 14B show this condition.

FIG. 14A shows a holding amount when the liquid holding member 61 is hanged by a wire, namely in a condition where the liquid holding member 61 is oriented in a condition where longitudinal direction is directed vertically. At first, the overall liquid holding member 61 hanged by the wire is dipped in the liquid to absorb the liquid in a condition as represented by the reference numeral 62. However, depending upon elapsed time, the liquid holding member is divided into a liquid holding region 63 and a non liquid holding region 64. A height of the liquid holding region 63 is determined depending upon a water head of a capillary force which is in turn determined depending upon density of the liquid holding member 61 and other factors. As set forth above, in the attitude where the longitudinal direction is directed in the vertical direction, the liquid holding member 61 can form the region not holding the liquid.

FIG. 14B shows similar liquid holding condition, wherein the liquid holding member 61 similar to that shown in FIG. 14A is placed within a container containing liquid 66 in the attitude directing the longitudinal direction thereof in the vertical direction. Even in this case, the liquid holding member 61 should form the liquid holding region 63 and the liquid not holding region 64. The height of the liquid holding region sucking the liquid and holding becomes the same as the case of FIG. 14A.

In the shown embodiment of the present invention, in viewpoint of difference of the liquid holding amount depending upon attitude, number of division and respective sizes of the liquid accumulating member 4 are determined. Namely, the liquid accumulating member 4 is, at first, not preferred for causing irregularity in the region where the liquid is transferred for presence of region not holding the liquid, upon transferring liquid. Secondly, it is not desirable to cause leakage of the liquid when the user handles or stores the liquid accumulating member in certain attitude. In this respect, in the embodiment of the present invention, range of size of the liquid accumulating member is determined depending upon water head determined by the capillary force of the liquid accumulating member so as not to cause leakage with holding the liquid over the entire region even when the liquid accumulating member is oriented with directing the longitudinal direction in the vertical direction Then, number of division is selected in order to realize the size of allowable range.

On the other hand, transferable number of the liquid transfer device is determined depending upon the initial liquid accumulation amount of the liquid accumulating member 4. Conversely, the liquid in the liquid accumulating member 4 maybe accumulated in amount depending upon a design value of the transferable number. Here, by determining the dimension of the liquid accumulating member so that the amount corresponding to the design value of the transferable number becomes maximum absorbing capacity, the liquid accumulating member may be formed into minimum size.

However, in practice, the liquid transfer device is considered to be stored or transported in various attitudes particularly in non-use condition and so on. The liquid transfer device is formed by mating the bottom surface of the surface supporting frame 6 and the mating portion 7a of the receptacle member 7 and joining them by heat seal. In this portion, the liquid accumulating member 4 is sealed. However, in practice, air and liquid may flow in and out through the porous film 5 or the transfer surface and thus, the liquid accumulating member 4 is exposed to the atmosphere. Then, in some attitude of the liquid transfer device, it may be possible to cause leakage of liquid through the porous film 5 or the transfer surface. The reason is that a liquid amount to be held by the liquid holding member, such as fibrous body, forming the liquid accumulating member 4 is basically determined depending upon the water head by the capillary force of the whole liquid holding member. Accordingly, in the liquid holding member having a given shape, the liquid amount to be held can be differentiated depending upon the attitude.

Again, discussion will be given with reference to FIGS. 14A and 14B. FIG. 14A shows holding amount when the liquid holding member 61 is hanged by the wire, namely the liquid holding member 61 is oriented with directing the longitudinal direction in the vertical direction. At first, the whole liquid holding member 61 hanged by the wire is dipped in the liquid to be in the condition indicated by 62. However, as time elapsed, the region 63 100% holding the liquid and a region 64 only partly holding the liquid are formed. The height of the liquid holding region 63 is determined by the water head of the capillary force depending upon density of the liquid holding member 61. The height of the region 63 is differentiated depending upon density of material of the absorbent body. In the case of PET having density of 0.2 g/cc, the height can be 90 to 100 mm, and in the case of PET having density of 0.65 g/cc, the height can be 70 to 80 mm.

FIG. 14B shows similar liquid holding condition, wherein the liquid holding member 61 similar to that shown in FIG. 14A is placed within a container containing liquid 66 in the attitude directing the longitudinal direction thereon in vertical direction. Even in this case, the liquid holding member 61 should form the liquid holding region 63 and the liquid not holding region 64. The height of the liquid holding region sucking the liquid and holding becomes the same as the case of FIG. 14A.

As set forth above, the liquid holding member 61 may form the region 64 only partly holding the liquid so that, in the condition exposed to the atmosphere, the liquid cannot be held in the region 64 may leak. Particularly, in the liquid accumulating member 4 used in the first embodiment, it is possible to be stored or handled in the attitude where the porous film 5 or transfer surface is not in horizontal condition, for example, the longitudinal direction of the liquid accumulating member 4 is directed in the vertical direction. In such a case, leakage of the liquid can be caused from the porous film 5 or transfer surface,

From such a viewpoint, size and shape of the liquid accumulating member 4 to be used in the first embodiment are determined. Namely, it is not desirable to cause leakage of the liquid at any attitude of the liquid accumulating member in handling or storing by the user.

Accordingly, the liquid accumulating member to be used in the first embodiment of the present invention takes an amount of liquid to be held without causing leakage as exposed to the atmosphere instead of the maximum absorbing amount of the liquid accumulating member as initial accumulating amount. Then, dimension and shape of the liquid accumulating member is determined so that the initial accumulating amount corresponds to the design value of the transferable number. Namely, the dimension and shape of the liquid accumulating member is determined in such a manner that the amount corresponding to the design value of the transferable number becomes greater volume than that obtained in the dimension and shape to achieve the maximum accumulation volume. More preferably, the dimension and shape are selected so that the amount of the liquid to be held without causing leakage when the porous film 5 or transfer surface is not oriented horizontally, for example, even when a primary surface or the longitudinal direction of the liquid accumulating member is oriented in the vertical direction.

Furthermore, upon determining the dimension and shape for corresponding to the predetermined transferable number and for avoiding leakage at any attitude, the following matters are considered.

Again, referring to FIG. 3B, the upper surface of the first embodiment of the liquid accumulating member 4 has a dimension S2 greater than a dimension S1 of the transfer surface, on which the printed product is mounted as surrounded by the surface supporting frame 6. Here, it is considered to match both dimensions, namely to take a construction where the entire upper surface of the liquid accumulating member 4 becomes the transfer surface. However in order to obtain the desired transferable number, the thickness of the liquid accumulating member 4 has to be increased correspondingly. However, from the initial use to the limit of transferable number, so that the liquid accumulating member 4 may appropriately cause elastic deformation in downward direction by depression force exerted through the pallet S, and by elastic deformation, the liquid accumulated in the liquid accumulating member 4 may be transferred to the printed product in appropriate amount just in proportion, excessively increasing of the thickness of the liquid accumulating member 4 is considered undesirable.

Therefore, in the shown embodiment, instead of dimension in the thickness direction of the liquid accumulating member 4, the liquid accumulating member 4 is formed so as to adapt to the desired transferable number and not to cause leakage at any attitude by increasing dimension in the primary surface to ensure the desired thickness. Namely, the liquid accumulating member 4 in the first embodiment holds the liquid even outside portion (peripheral portion) of a substantially quadratic pole extending through the transfer surface and a projection of the transfer surface on the bottom surface.

It should be noted that while consideration is given for the liquid holding ability of only liquid accumulating member 4 in the foregoing construction, the porous film 5 may also create capillary force. Therefore, the desired accumulation amount corresponding to the design value of the transferable number and the dimension of the liquid accumulating member 4 corresponding thereto may be determined with taking the liquid holding amount into consideration when the longitudinal direction of the porous film 5 is oriented in the vertical direction.

On the other hand, in consideration of the size, cost and so on of the entire liquid transfer device 1 set forth above, amount of the liquid to be stored in the liquid accumulating member 4 has a given limit. Associating with this, there is a given limit even for the transferable number of the liquid to the transfer object. It should be noted that, in the shown embodiment, for the printed product of post card size, about 130 times of liquid transfer can be performed at the maximum.

In this case, it Is quite inconvenient for the user not to see the remaining amount of the liquid in the liquid accumulating member 4. Particularly, since the liquid is basically transparent, it should be difficult for the user to check whether transfer is certainly performed or not by viewing the printed product. In fact, it is possible that the liquid transfer operation is performed despite of the fact that the liquid is not remained in the liquid accumulating member 4.

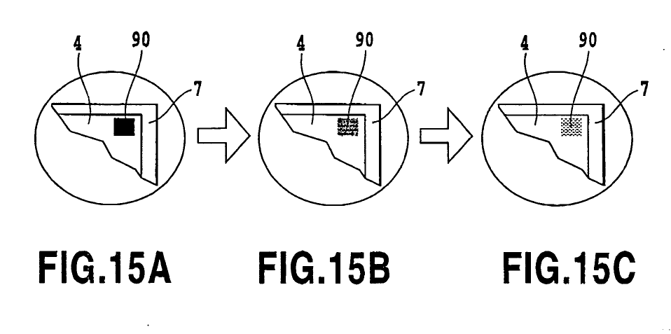

In view of this, the liquid transfer device 1 according to the present invention is provided with the colored member 90 which can be visually seen through the liquid accumulating member 4. Associating with increasing of number of times of transfer of the liquid, transmission ratio or coefficient of the liquid accumulating member 4 may be varied (reduced). Associating with variation of transmission ratio of the liquid accumulating member 4, as shown in FIGS. 15A to 15C, visible conditions of the coloring agent 90 can be varied (deteriorated) via the reception member 7 and the liquid accumulating member 4. Accordingly, in the liquid transfer device 1, the user may monitor the liquid remaining amount in the liquid accumulating member 4 based on the viewing condition of the colored member 90 via the liquid accumulating member 4.

Here, in the shown in embodiment, as can be seen from FIG. 9B, the colored member 90 is embedded within the liquid accumulating member 4 so as not to overlap with the porous film 5 (transfer zone) exposed through the opening portion 6a as viewed from right above (on the side of the surface supporting frame 6). Therefore, the user may observe the colored member 90 from back surface side of the liquid transfer device 1 through the receptacle member 7 and the liquid accumulating member 4. As set forth above, by embedding the colored member 90 in the liquid accumulating member 4 so as not to overlap with the porous film 5 (transfer zone) exposed from the opening portion 6a, presence of the colored member 90 may not serve as hindrance for flow of the liquid from the liquid accumulating member 4 to the porous film 5.

It is also possible to embed the colored member 90 to overlap with the porous film 5 (transfer zone) exposed from the opening portion 6a. By this, the colored member 90 becomes visible from the transfer zone side. Therefore, it becomes unnecessary to form the receptacle member 7 from a transparent member.

On the other hand, with the foregoing liquid transfer device 1, for the printed product of post card size, about 130 times of liquid transfer can be performed at the maximum. However, the shown embodiment of the liquid transfer device 1 is designed so that the colored member 90 becomes invisible through the liquid accumulating member 4 and the receptacle member 7 when about 100 times of liquid transfer is completed in consideration of the user not familiar with the liquid transfer operation and for the purpose of providing sufficient margin in the liquid remaining amount.

In this case, a relationship between the view condition of the colored member 90 and the remaining amount of the liquid in the liquid accumulating member 4 may be adjusted by varying a burying height or depth of the colored member 90 in the liquid accumulating member 4. In the shown embodiment, under characteristics of the liquid set forth S above, conditions of respective members, i.e. material, dimension and so forth, the colored member 90 becomes invisible through the liquid accumulating member 4 and the receptacle member 7 when about 100 times of liquid transfer is completed when the colored member 90 is embedded at substantially center (at a height position 2 mm from the bottom) in the height direction of the liquid accumulating member 4 of 4 mm thick.

As set forth, in the liquid transfer device 1, depending upon the transmission ratio of the liquid accumulating member 4 variable associating with increasing of number of times of liquid transfer, the view condition of the colored member 90 via the liquid accumulating member 4 is varied. Therefore, the user may perform the transfer operation of the liquid for the printed product PM with comprehending the liquid remaining amount of the liquid accumulating member 4. As a result, with the liquid transfer device 1, the liquid can be certainly and uniformly transferred to the printed product to improve durability of the image with maintaining image texture of the image, and to significantly improve convenience in transfer operation.

(Second Embodiment)

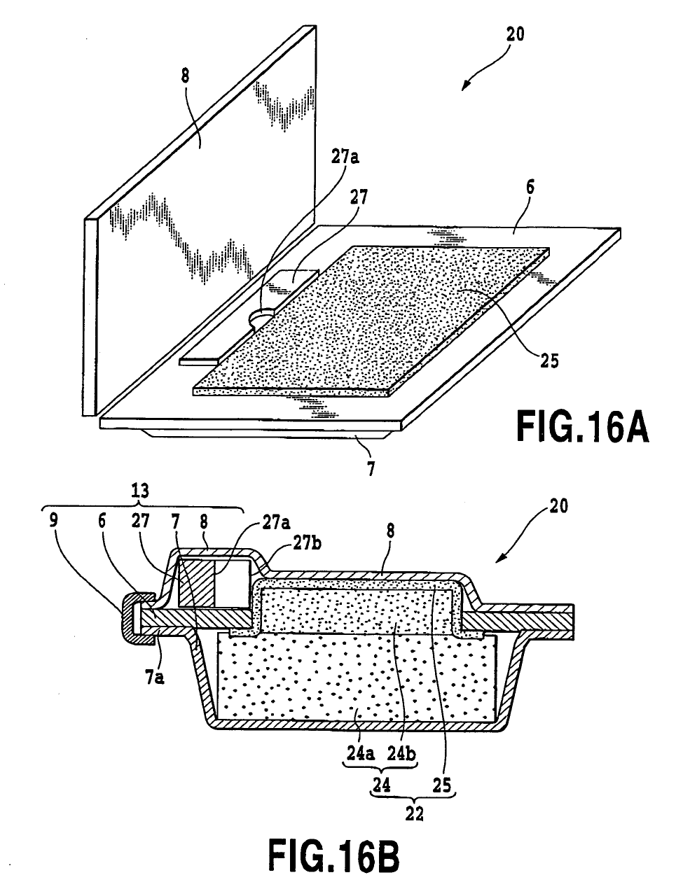

Next, the second embodiment of the liquid transfer device 20 according to the present invention will be discussed with reference to FIGS. 16A to 20G. It should be noted that like components to those discussed in connection with the first embodiment will be identified by like reference numerals, and discussion for such common components will be eliminated for avoiding redundant disclosure for keeping the disclosure simple enough to facilitate clear understanding of the present invention.

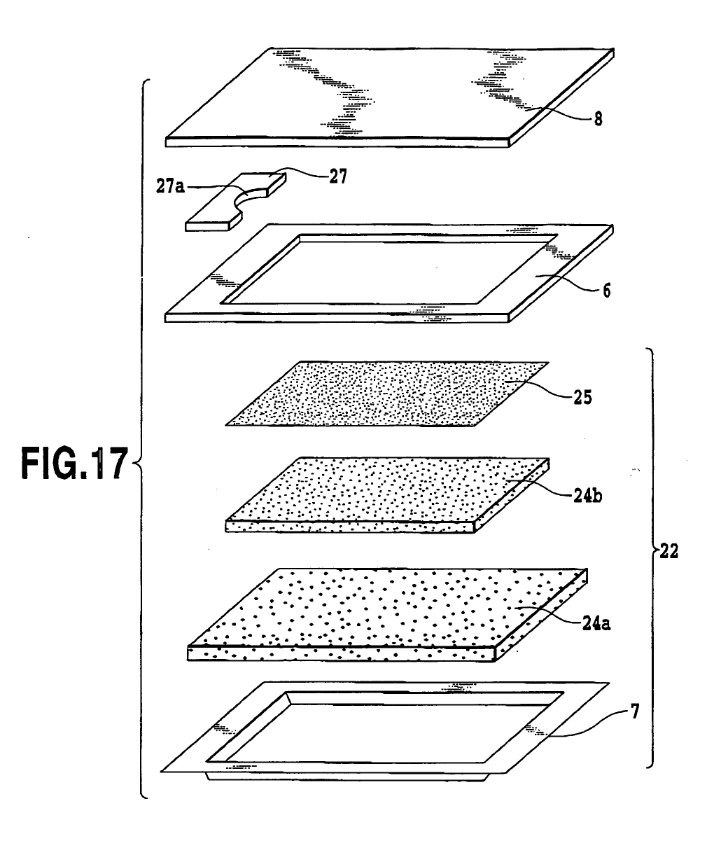

The second embodiment of the liquid transfer device 20 is constructed with the liquid transfer member 22 accumulating a liquid for enhancing durability of a printed product and transferring the liquid on the printed surface of the printed product, and the holding member 13 holding a circumference of the liquid transfer member 22 similarly to the first embodiment of the liquid transfer device 1. It should be noted that while the liquid accumulating member in the first embodiment has a single layer structure, the shown embodiment of the liquid accumulating member 24 has a structure of plurality of layers (two layers) having mutually different liquid holding ability (capillary force) as shown in FIGS. 16A, 16B and 17. Namely, as shown in FIG. 16B, the liquid accumulating member 24 has a low density layer 24a formed from a sheet form member having relatively low density (0.065 g/cc) and a high density layer 24b formed from a sheet form member fitted on a (upper) surface of the low density layer 24a and having relatively high density (0.2 g/cc). On the other hand, a dimension of the low density layer 24a is thicker than the high density layer 24b and has greater area. Here, the dimension (longitudinal dimension x lateral dimension x thickness) of the low density layer 24a is 178 mm×130 mm×4.0 mm, and the dimension (longitudinal dimension×lateral dimension×thickness) of the high density layer 24b is 150 mm×106 mm×1.5 mm.

A surface (upper surface) of the liquid accumulating member 24 is covered with a porous film 25. With the porous film 25 and the liquid accumulating member 24 (24a, 24b), liquid transfer member 22 is formed. The porous film 25 is formed from the material similar to that of the porous film 5 discussed in connection with the first embodiment. The peripheral edge portion of the porous film 25 is secured to the bottom surface (lower surface) of the quadrangular surface supporting frame 6 forming a part of the holding member 13. On the other hand, the holding member receiving the liquid transfer member 22 includes a contact plate 27 having a predetermined thickness (1.5 mm) secured along one edge of the surface supporting frame 6 Furthermore, in the holding member 13, similar to the first embodiment, the surface supporting frame 6, the receptacle member 7, the lid 8, the connecting member and so forth are included. With such holding member 13, the liquid transfer member 22 can be retained without causing drop out.

It should be noted that, in the second embodiment, within the opening portion 6a of the surface supporting frame 6, the high density layer 24b as covered by the porous film 25 is engaged for allowing the porous film 25 and the high density layer 24b to project upwardly from the surface of the surface supporting frame 6 to form the transfer zone. Then, the printed product PM is mounted on the surface of the porous film 25 projecting upwardly. The contact plate 27 is used for positioning of the printed product PM when the printed product is mounted on the transfer zone. The contact plate 27 is formed with a recessed portion 27a for facilitating removal of the printed product.

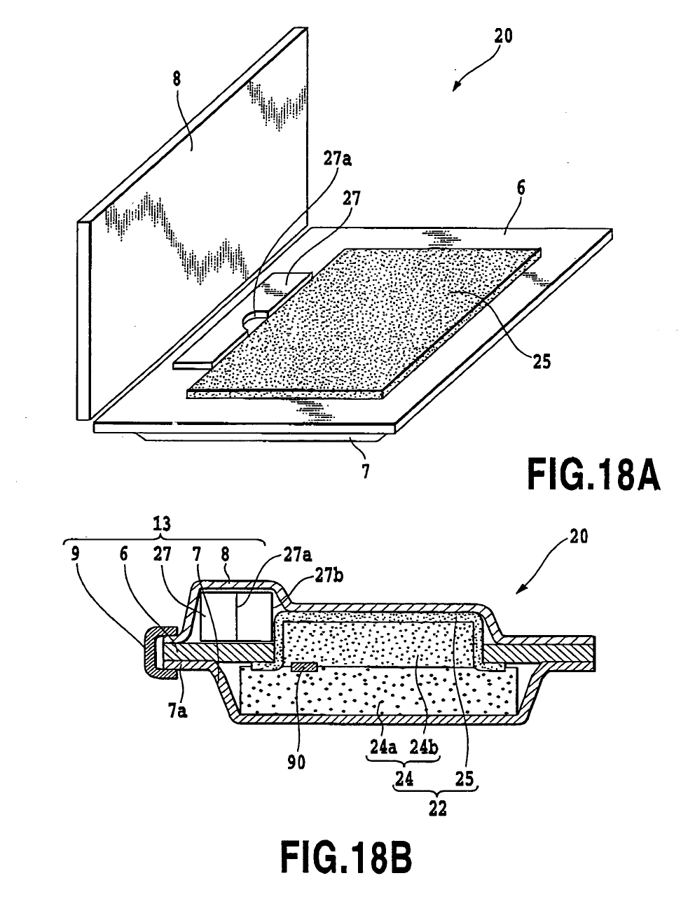

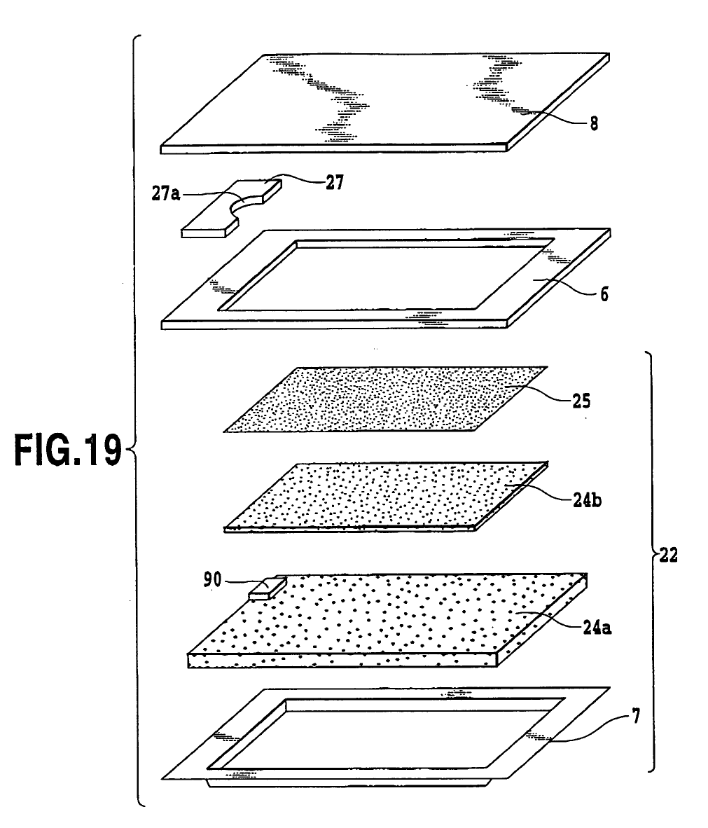

A first modification of the second embodiment is formed by embedding the colored member (remaining amount detecting body) 90 in the liquid accumulating member 24 for monitoring the remaining amount of the liquid similarly to the second modification of the first embodiment, as shown in FIGS. 18A, 18B and 19. In the liquid transfer device 20, the colored member 90 is sandwiched between the low density layer 24a and the high density layer 24b. As can be appreciated from FIG. 18B, the colored member 90 is embedded in the liquid accumulating member 24 for overlapping with the porous film 5 (transfer zone) exposed from the opening portion 6a as viewed from right above (surface supporting frame 6 side). The colored member 90 is viewed from both of the transfer zone side and the receptacle member 7 and the low density layer 4a side.

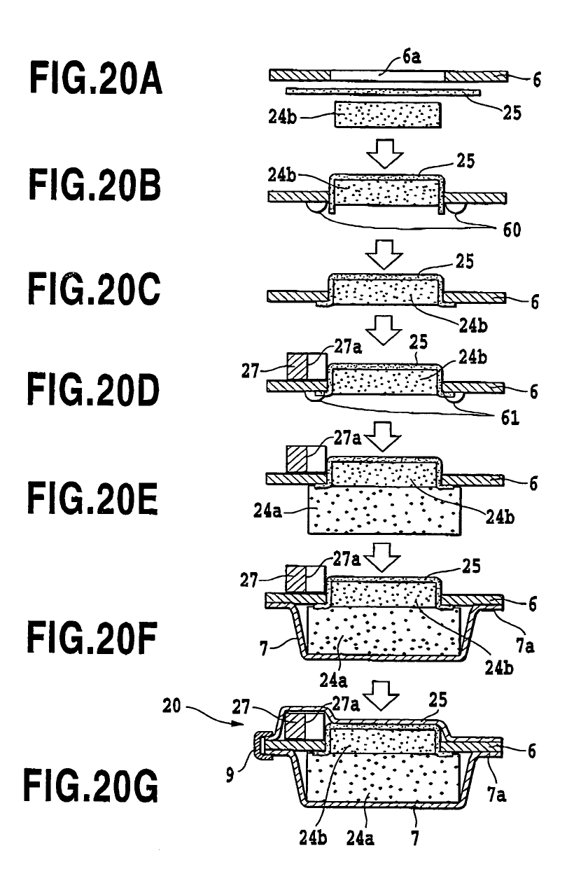

Next, discussion will be given for procedure in manufacturing of the second embodiment of the liquid transfer device 20 with reference to FIGS. 20A to 20G. In this case, at first, the surface supporting frame 6, the porous film 25 and the high density layer 24b are prepared. After covering the surface of the high density layer 24b with the porous film 25, the high density layer 24b covered with the porous film 25 is inserted into the opening portion 6a of the surface supporting frame 6 (see FIGS. 20A, 20B and 20C). Then, the peripheral edge of the porous film 25 projecting downwardly from the surface supporting frame 6 is bent along the opening portion 6a of the surface supporting frame 6. A bent portion is bonded to the surface supporting frame 6 by adhesive 60. Furthermore, the contact plate 27 is bonded on the surface of the surface supporting frame 6 (see FIG. 20D).

Furthermore, these four members 6, 25, 24b and 27 are placed on the low density layer 24a sandwiching the colored member 90 (see FIG. 19 but not shown in FIGS. 20A to 20G) (see FIG. 20E), and are then received within the receptacle member 7. Then, the bottom surface of the surface supporting frame 6 and the mating portion 7a of the receptacle member 7 are overlaid with each other and bonded by heat seal leaving the liquid pouring opening (see FIG. 20F).

In the second embodiment, the internal depth of the receptacle member 7 is set about 2 mm. By thermo compression bonding of the surface supporting frame 6 and the mating portion 7a, the low density layer 24a is compressed to have a thickness of about 2 mm. Subsequently, similarly to the first embodiment, pouring of the liquid into the liquid accumulating member 24 and discharging of internal air are performed using the liquid pouring opening. After discharging air, the liquid pouring opening is closed by heat seal. Finally, the lid 8 is connected to the receptacle member 7 via the connecting member 9 to complete the liquid transfer device 20 (see FIG. 20G).

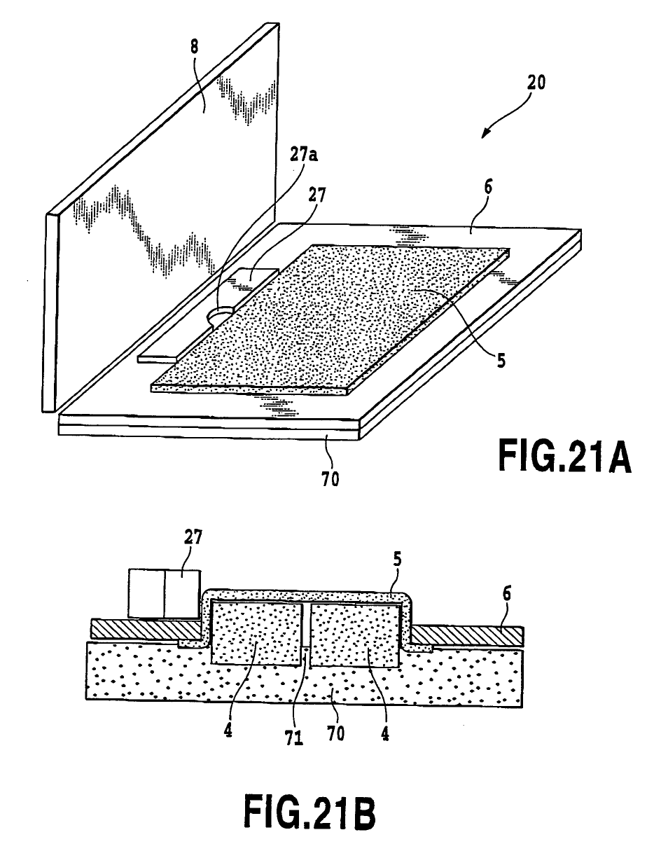

On the other hand, FIGS. 21A and 21B are illustrations showing the second modification of the second embodiment of the liquid transfer device according to the present invention. FIG. 21A is a perspective view showing a construction of the second modification of the second embodiment of the liquid transfer device, and FIG. 21B is a cross section of the liquid transfer device shown in FIG. 21A.

The second modification of the second embodiment of the liquid transfer device is constructed with the liquid transfer member accumulating the liquid for improving durability of the image of the printed product, and the holding member for holding the circumference of the liquid accumulating member. The front surfaces (upper surfaces) of the liquid accumulating member 4 divided into six fractions are covered by the porous film 5. The porous film 5 and respective fractions of the liquid accumulating member 4 form the liquid transfer member. The porous film 5 is formed from the similar material as the porous film 5 discussed in connection with the first embodiment. The peripheral portion of the porous film 5 is bonded on the bottom surface (lower surface) of the quadrangular surface supporting frame 6 by adhesive.

In the shown modification, within the opening portion of the surface supporting frame 6, six fractions of the liquid accumulating member 4 covered by the porous film 5 are inserted so that the upper surfaces thereof may project upwardly from the surface of the surface supporting frame 6. Then, the printed product is mounted on the surface of the porous film 5 projecting upwardly. Therefore, in order to facilitate positioning and so on upon mounting the printed product, the contact plate 27 is provided on the surface supporting frame 6. It should be noted that the recessed portion 27a is formed in the contact plate 27 in order to facilitate removal of the printed product.

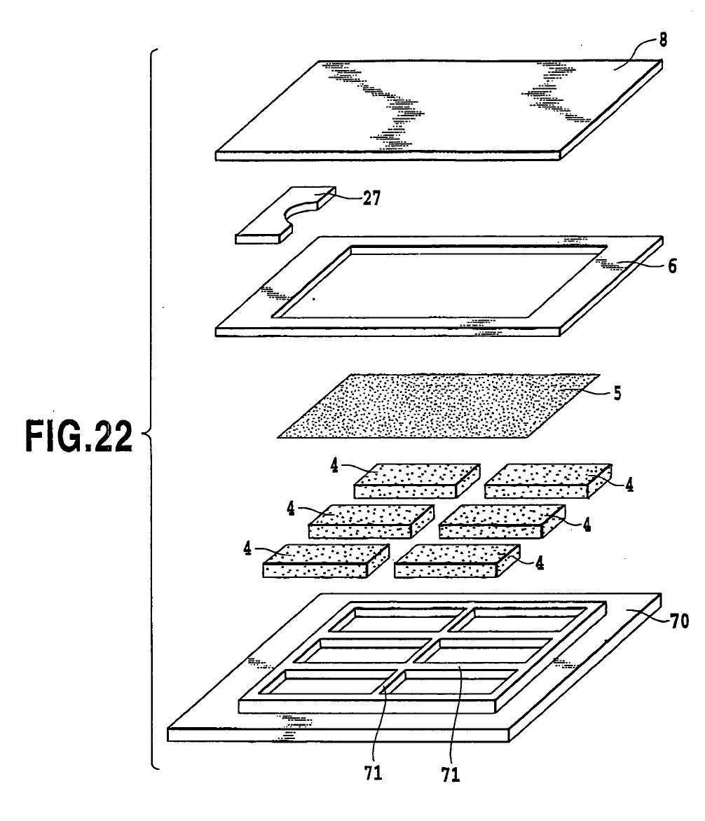

FIG. 22 is an illustration for explaining a manufacturing process of the second modification of the second embodiment of the liquid transfer device.

The surface supporting frame 6, the porous film 5 and the liquid accumulating member 4 divided into six fractions are prepared. After covering the surface of the six fractions of the liquid accumulating member 4 with the porous film 5, the liquid accumulating member 4 covered with the porous film 5 is inserted into the opening portion 6a of the surface supporting frame 6. Then, the peripheral edge of the porous film 5 projecting downwardly from the surface supporting frame 6 is bent along the opening portion 6a of the surface supporting frame 6. A bent portion is bonded to the surface supporting frame 6 by adhesive 60. Furthermore, the contact plate 27 is bonded on the surface of the surface supporting frame 6.

Next, the respective of the foregoing members are placed on the receptacle member 7 in such a manner that respective divided fractions of the liquid accumulating member 4 are received within receptacle chambers defined in the receptacle member 7 by partitioning walls 71. The bottom surface of the surf ace supporting frame 6 and the mating portion of the supporting member 70 are bonded by heat seal. Subsequently, similar to the first embodiment, liquid is supplied to the liquid accumulating member 4. Finally, the lid 8 Is connected to the receptacle member by the connecting member to complete manufacturing of the liquid transfer device.

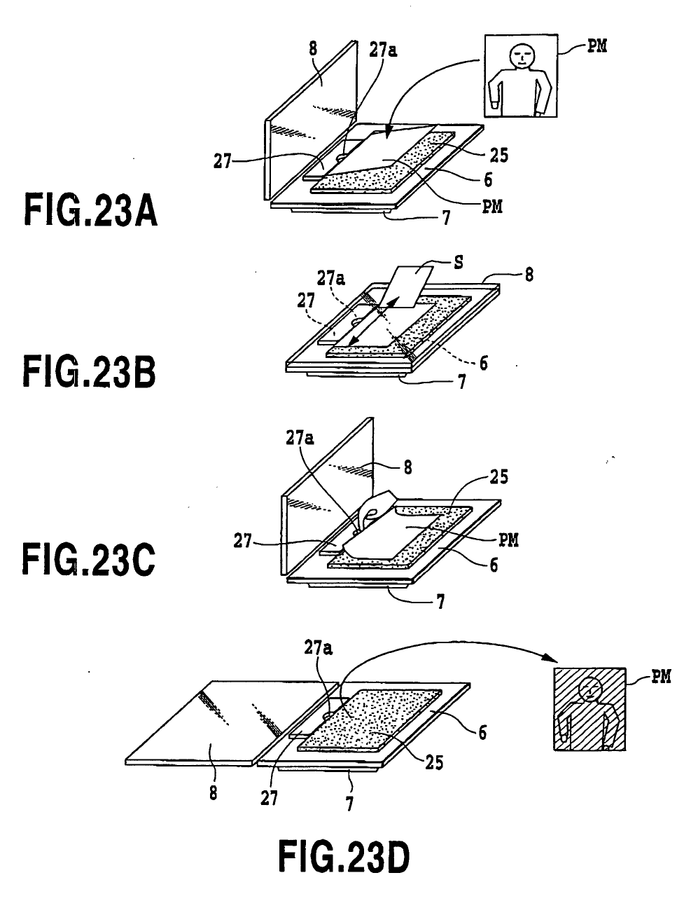

Even in the second embodiment of the liquid transfer device 20 constructed as set forth above, an appropriate amount of liquid can be transferred to the printed product by quite simple operation as shown in FIGS. 23A to 23D. In this case, the porous film 5 is exposed by opening the lid 8, and the printed product is mounted on the porous film 5 holding the liquid (see FIG. 23A). Next, the lid 8 is closed and the printed product is depressed for several times through the lid 8 by the pallet S. Again, by opening the lid 8 again, the printed product is peeled off the porous film 5 and is removed (see FIG. 23D).

In such a liquid transfer operation, by applying depression force by the pallet S, the low density layer 24a having low density is caused elastic deformation in greater magnitude than that of the high density layer 24b to exude relatively large amount of liquid held therein by elastic deformation toward the surface side (upper side). The liquid exuded from the low density layer 24a is sucked by the higher density layer 24b having greater liquid holding ability (capillary force). The sucked liquid is fed to the porous film 25 having higher liquid holding ability than that of the high density layer 24b. Liquid from the lower side is transferred, while the exuding amount toward outside is restricted by the porous film 25, to the ink receptacle layer of the printed product.

As set forth above, in the second embodiment where the high density layer 24b and the low density layer 24a provided lower density (easily squeezed and having lower liquid holding ability) are provided in the liquid accumulating member 24, the liquid can be smoothly fed toward the porous film 25. Accordingly, even without applying large depression force by the pallet S, liquid transfer can be performed. In other words, when remaining amount of liquid in the liquid accumulating member 24 becomes small, smooth liquid transfer can be realized since the low density layer 24a can be elastically deformed easily. Thus, transferable number can be increased as compared with that in the first embodiment. In experiments, for the first and second embodiments of the liquid transfer device 1 and 20, the liquid was supplied to establish the same liquid accumulation amount, and number of times of liquid transfer was counted. As a result, number of times of liquid transfer in the second embodiment of the liquid transfer device 20 is greater than that achieved by the first embodiment of the liquid transfer device 1 in the extent of 20 to 30 times. Namely, when about 30 to 50 times of liquid transfer was possible in the first embodiment, about 70 times of liquid transfer was possible in the second embodiment.

On the other hand, since the low density layer 24a easily causes elastic deformation, even when bending or irregularity of shape are present in the printed product PM, the porous film 25 may be fitted to the surface of the printed product more flexibly to further ensure uniform liquid transfer.

It should be noted that while the liquid accumulating member 24 is formed by laminating two sheet form members having mutually different densities in the second embodiment, it is also possible to provide different density in the thickness direction of the liquid accumulating member even with the single member. For example, by compressing and heating one surface side of the single member, density can be differentiated in the single member Accordingly, depending upon manner of application of the pressure, it is possible to provide different density in upper and lower two stages or, in the alternative, to provide gradient in density so as to gradually vary the density from the front surface side to the back surface side. Then, even in this case, similar effect can be obtained to the case where two members having different densities are laminated as in the shown embodiment.

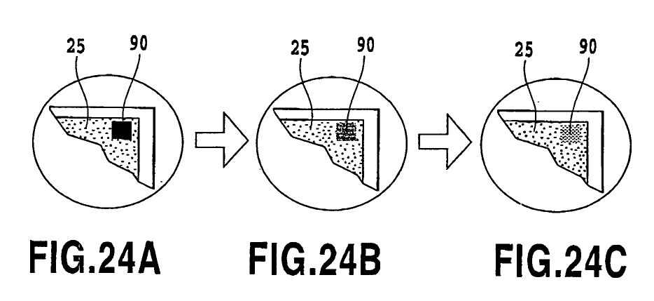

Furthermore, the first modification of the second embodiment of the liquid transfer device 20 also has the colored member 90 which is visible through the receptacle member 7 and the low density layer 24a. Then, even in the shown modification, the transmission ratio or coefficient of the liquid accumulating member 24 is varied (decreased) associated with increasing of number of times of liquid transfer. Depending upon variation of the transmission coefficient of the liquid accumulating member 4, view condition of the colored member 90 is varied (deteriorated) via the porous film 25 and the high density layer 24b as shown in FIGS. 24A to 24C. (It should be noted that the colored member 90 is shown as viewed from the transfer zone in FIGS. 24A to 24C.) Accordingly, in the liquid transfer device 20, user may monitor the liquid remaining amount in the liquid accumulating member 4 on the basis of view condition of the colored member 90 via the liquid accumulating member 4. As a result, with observing the liquid remaining amount of the liquid accumulating member 24, liquid transfer operation for the printed product can be performed. Therefore, by the liquid transfer device 20, the liquid can be certainly and uniformly transferred to the printed product to improve durability of the image with maintaining image texture of the image. Also, workability in the liquid transfer operation can be improved significantly.

On the other hand, in the first modification of the second embodiment of the liquid transfer device 20, a relationship between the view condition of the colored member 90 and the liquid remaining amount in the liquid accumulating member 24 can be adjusted by varying thickness of the low density layer 24a of the liquid accumulating member 24. Namely, in the shown embodiment, under the characteristics of the foregoing liquid and the conditions of the quality of material, dimension and so on of respective members, the low density layer 24a of about 4 mm thick can be compressed into 2 mm thick, the colored member 90 sandwiched between the low density layer 24a and the high density layer 24b becomes invisible from either sides of the transfer zone (side of the porous film 25 and the high density layer 24b) and the receptacle member 7 and the low density layer 24a upon completion of about 100 times of liquid transfer. It should be noted that, in the shown embodiment, the colored member 90 may be embedded within the liquid accumulating member 24 so as not to overlap with the porous film 5 (transfer zone) exposed from the opening portion 6a.

(Construction of Second Embodiment of Liquid Accumulating Member)

Even for the liquid accumulating member 24 applied for the second embodiment, dimensions and shapes of a first layer 24a and a second layer 24b forming the liquid accumulating member 24 are determined optimally similarly to the first embodiment.

Here, the liquid holding ability of the liquid accumulating member 24 becomes an integrated value of the liquid holding abilities of respective first layer 24a and the second layer 24b as measured individually.

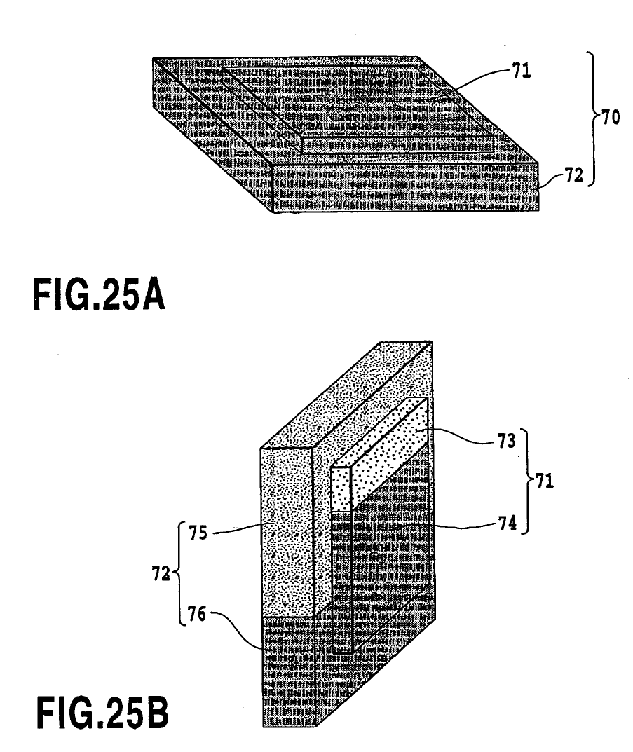

The holding ability of the liquid accumulating member 24 will be discussed with reference to FIGS. 25A and 25B. As shown in FIG. 25A, a liquid accumulating member 80 formed by laminating a second layer 81 formed of PET having density of 0.25 g/cc and a first layer 82 formed of PET having density of 0.065 g/cc is dipped in the liquid, for example. After completely impregnating the liquid in the liquid accumulating member 80, the liquid accumulating member 80 is oriented with directing the longitudinal direction thereof in the vertical direction. Then, as shown in FIG. 25B, respective layers are divided into regions 84 and 86 100% holding the liquid and regions 83 and 85 only partly holding the liquid. The holding ability of the liquid of the liquid accumulating member 24 becomes a sum of the liquid holding ability of the second layer 81 and the liquid holding ability of the first layer 82. In this case, a height of the portion 100% holding the liquid is about 100 mm for the second layer 81 and a height of the portion 100% holding the liquid is about 80 mm for the first layer 82.

Therefore, concerning respective layers, in the condition where the liquid accumulating member 80 is oriented with directing the longitudinal direction thereof in the vertical direction as shown in FIG. 25B, the integrated value of the amount of the liquid held without causing leakage is an initial accumulation amount of the liquid accumulating member 80 or 24. Dimension and shape of respective portions of the liquid accumulating portion (member) are determined so as to achieve the initial accumulation amount corresponding to the design value of transferable number.

Furthermore, upon determining dimension and shape corresponding to the predetermined transferable number and not causing leakage at any attitude, in consideration similar to the first embodiment, the upper surface of the first layer 24a of the liquid accumulating member 24 is provided with greater dimension that the transfer surface on which the printed product is mounted as surrounded by the surface supporting frame 6 and the dimension of the bottom surface of the second layer 24b matching with the transfer surface.

It should be noted that consideration is given only for the liquid holding abilities of only first layer 24a and the second layer 24b of the liquid accumulating member 24 in the foregoing construction. However, since the porous film 25 also has capillary force, it may be possible to take into account the liquid holding ability of the porous film in the orientation where the longitudinal direction thereof is directed in the vertical direction. Concerning the porous film formed of PTFE employed in the shown embodiment, when the porous film is oriented where the longitudinal direction thereof is directed in vertical direction, height of the region 100% holding the liquid is 200 mm. Sharing the liquid holding amount to the first layer and the second layer, the initial liquid accumulation amount is determined, and dimension and shape of respective portions of the liquid accumulating portion are determined so as to achieve initial accumulation amount corresponding to the design value of transferable number.

On the other hand, a total liquid holding ability can be varied by increasing density of the porous film. It was also confirmed that fine adjustment of the total holding ability could be done by overall transfer speed and strength against leakage.

(Third Embodiment)

Next, the third embodiment of the liquid transfer device according to the present invention will be discussed.

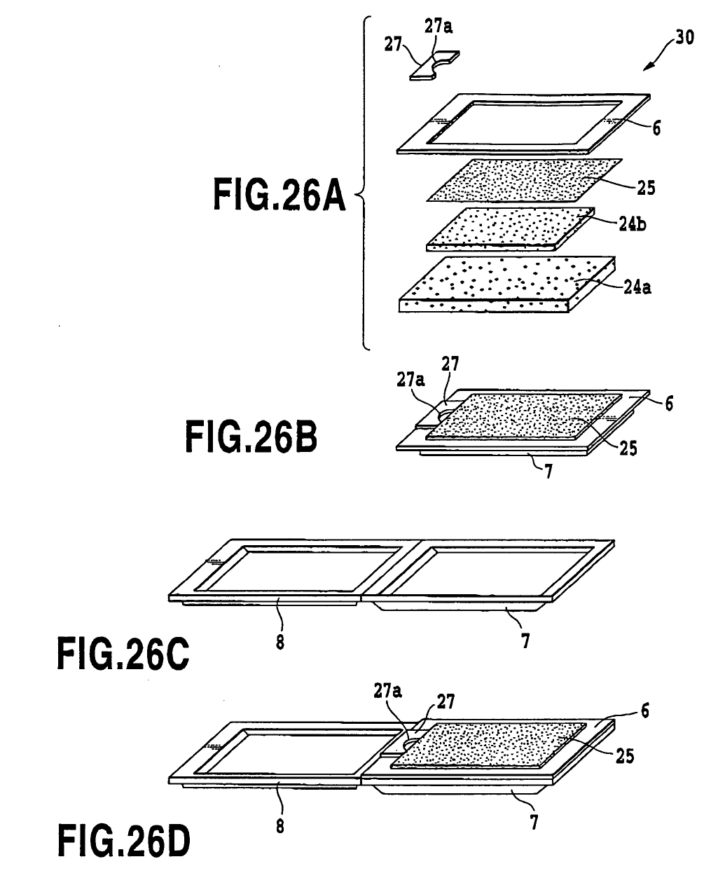

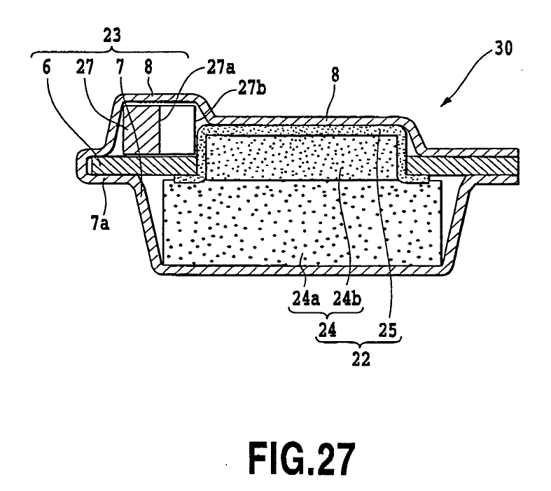

In the foregoing first embodiment and the second embodiment, the receptacle member 7 and the lid 8 are formed separately and connected by the connecting member 9. The lid and the receptacle member may be formed integrally as the third embodiment of the liquid transfer device 30 according to the present invention as shown in FIGS. 26A to 27.

Namely, in the third embodiment, in the holding member 23 holding the liquid transfer member 22 similar to the second embodiment, the lid 8 and the receptacle member 7 are molded integrally by vacuum molding. Accordingly, with the third embodiment, the lid 8 and the receptacle member 7 can be molded in one process step. Also, steps of forming the connecting member and connecting the lid and the receptacle member with the connecting member can be eliminated to permit manufacturing at lower cost. The lid 8 in the third embodiment is always provided with three-dimensional shape complementary with the shape of the upper surface of the liquid transfer member 22. It should be noted that like components to those discussed in connection with the second embodiment will be identified by like reference numerals, and discussion for such common components will be eliminated for avoiding redundant disclosure for keeping the disclosure simple enough to facilitate clear understanding of the present invention.

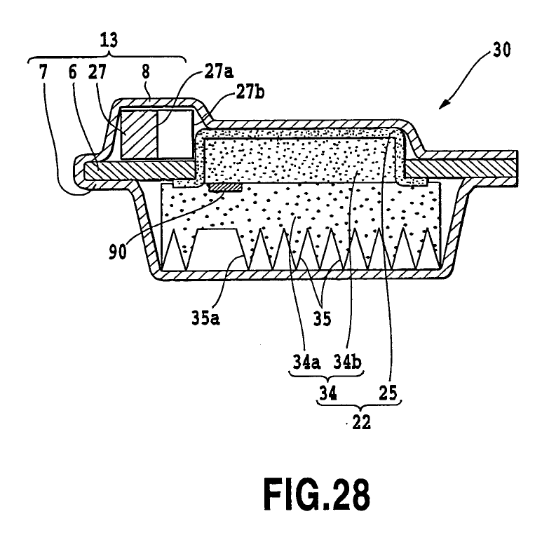

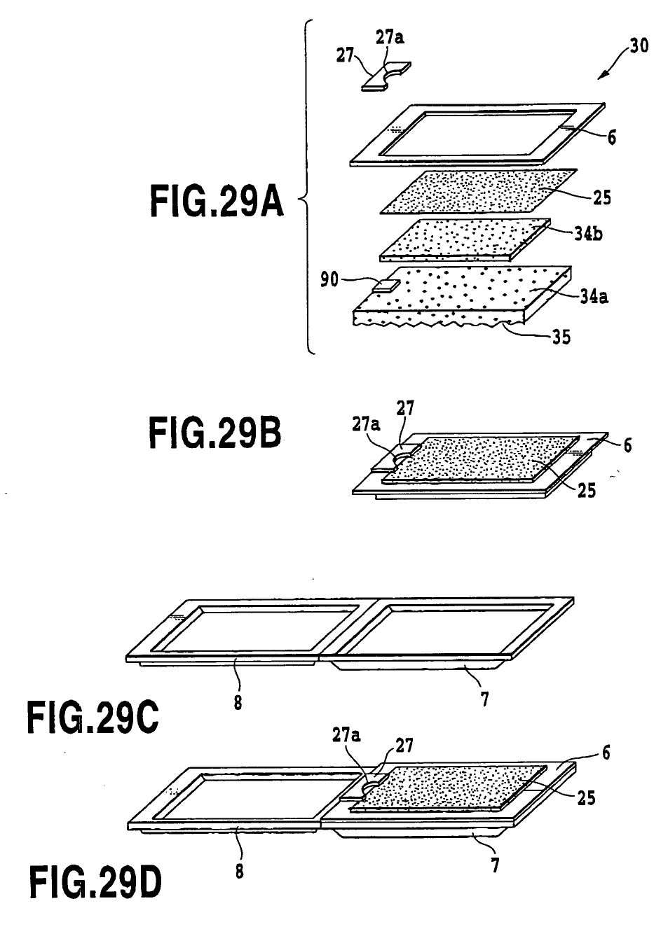

Hereinafter, the first modification of the third embodiment of the liquid transfer device according to the present invention will be discussed with reference to FIGS. 28 to 29D. It should be noted that like components to those discussed in connection with the third embodiment will be identified by like reference numerals, and discussion for such common components will be eliminated. In the first modification, the receptacle member 7 and the lid 8 are molded integrally by vacuum molding as set forth above. By this, the manufacturing cost can be lowered.

On the other hand, in the first modification, as shown in FIG. 28, a plurality of recessed portions (grooves) 35 are formed with a given interval on the lower surface of a low density layer 34a forming a liquid accumulating member 34. The recessed portions 35 are formed so as to be oriented in vertical direction when the liquid transfer device 20 is placed in vertical orientation. In the first modification of the shown embodiment, when the liquid transfer device 30 is placed in vertical orientation, it is normally placed orienting the longitudinal direction thereof in vertical direction. Therefore, the recessed portions 35 are formed in parallel to the longitudinal direction of the liquid accumulating member 34. Here, the recessed portion 35 may have V-shaped cross section as shown in FIG. 28 or U-shaped cross section (not shown). These recessed portions 35 can be formed by urging a hot wire developing Joule heat or by cutting.

The cross-sectionally V-shaped recessed portions 35 enhance cushioning characteristics of the liquid accumulating member 34 in vertical direction (thickness direction). Therefore, even when a material having relatively high density and relatively high liquid holding ability, exuding ability of liquid during liquid transferring operation can be enhanced by the cushioning characteristics to permit increasing of the number of times of liquid transfer. On the other hand, when a material having high liquid holding ability is used, local concentration of the liquid to the lower portion can be reduced even when the liquid transfer device 30 is oriented vertically. Furthermore, locally concentrated liquid in the lower portion can be smoothly dispersed over the entire area along the recessed portions 35 when the liquid transfer device 30 is returned to horizontal orientation. Thus, liquid transfer operation can be started or resumed quickly.

On the other hand, cross-sectionally U-shaped recessed portions may also be easily formed by urging the hot wire developing Joule heat. Such cross-sectionally U-shaped recessed portions may enhance cushioning characteristics of the liquid transfer member 34. Also, the cross-sectionally U-shaped recessed portions may enhance flowability of the liquid in comparison with the recessed portions having V-shaped cross-section. Therefore, when the liquid transfer device 30 is used in horizontal orientation, the liquid can be distributed over the entire area of the liquid accumulating member 34 more quickly.

In the first modification of the third embodiment, as shown in FIG. 28, by forming recessed portions 35a on the lower portion of the lower density layer 24a located on the lower side of the colored member 90, a relationship between view condition of the colored member 90 and the liquid remaining amount in the liquid accumulating member 34 is adjusted, Namely, in the first modification, instead of reducing thickness by compressing the low density layer as in the second embodiment, the thickness of the portion of the low density layer 34a corresponding to the colored member 90 is reduced by forming the recessed portions 35a on the lower surface of the low density layer 34a. Even with employing such construction, upon timing where the predetermined number of times of liquid transfer is completed, lacking of the remaining amount of the liquid in the liquid accumulating member 34 can be noticed from the view condition of the colored member 90.

(Fourth Embodiment)

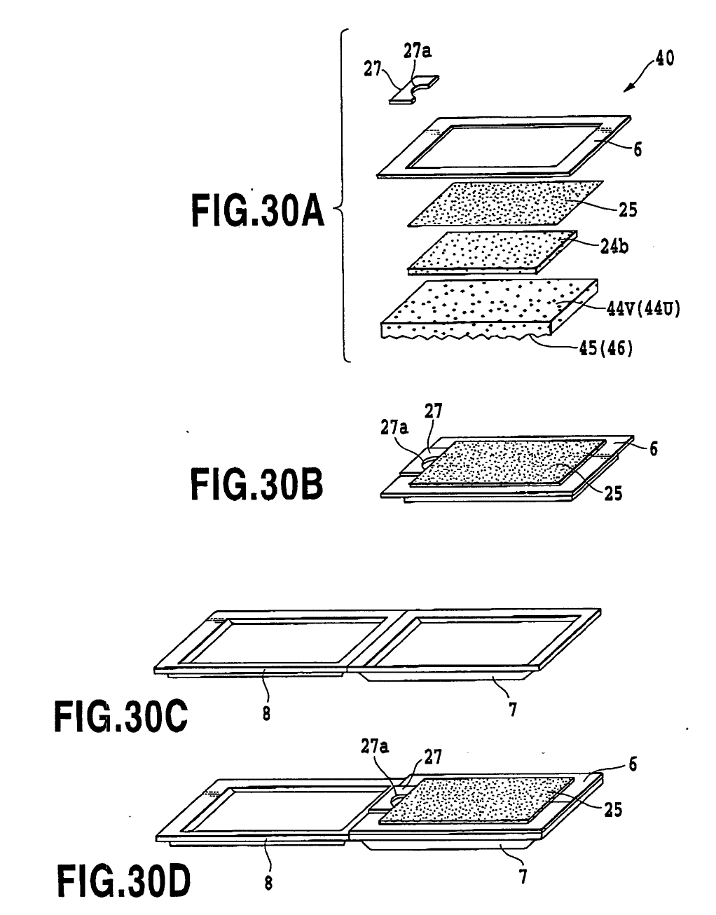

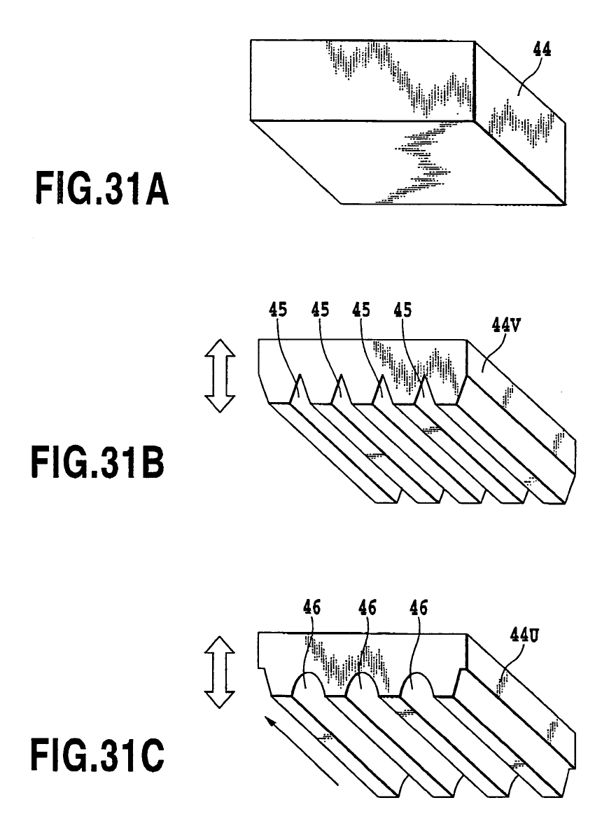

Next, the fourth embodiment of the liquid transfer device according to the present invention will be discussed with reference to FIGS. 30A to 31C.

The fourth embodiment is formed by forming a plurality of stripe form grooves 45 or 46 with a given interval on the lower surface of a liquid accumulating member 44 (see FIG. 31A) in the third embodiment set forth above, as shown in FIGS. 31B and 31C. These grooves 45 or 46 are formed along a direction of gravity upon orienting the liquid transfer device 40 vertically. Upon orienting the liquid transfer device 40 vertically, the longitudinal direction is normally oriented in vertical direction. The grooves 45 or 46 are formed along the longitudinal direction of the liquid accumulating member 44.

Here, the grooves 45 shown in FIG. 31B are the grooves of cross-sectionally V-shaped configuration. These grooves may be formed by urging a hot wire developing Joule 5 heat or cutting the lower surface of the liquid accumulating member 44 shown in FIG. 31A.

With a liquid accumulating member 44V formed with the cross-sectionally V-shaped grooves 45, cushioning characteristics of the liquid accumulating member can be enhanced in vertical direction (thickness direction) by the grooves, as shown by arrow. Therefore, even when a material having relatively high density and relatively high liquid holding ability, exuding ability of liquid during liquid transferring operation can be enhanced by the cushioning characteristics to permit increasing of the number of times of liquid transfer. On the other hand, when a material having high liquid holding ability is used, local concentration of the liquid to the lower portion can be reduced even when the liquid transfer device 40 is oriented vertically. Furthermore, locally concentrated liquid in the lower portion can be smoothly dispersed over the entire area along the grooves 45 when the liquid transfer device 44 is returned to horizontal orientation. Thus, liquid transfer operation can be started or resumed quickly.

On the other hand, cross-sectionally U-shaped grooves 46 shown in FIG. 31C may be easily formed by urging a hot wire developing Joule heat. Such cross-sectionally U-shaped grooves 46 may enhance cushioning characteristics of the liquid transfer member 44U similarly to the ca e where the cross-sectionally V-shaped grooves 45 are formed. Also, the cross-sectionally U-shaped recessed portions may enhance flowability of the liquid in comparison with the recessed portions having V-shaped cross-section. Therefore, when the liquid transfer device 40 is returned to be used in horizontal orientation, the liquid can be distributed over the entire area of the liquid accumulating member 44U more quickly.

It should be noted that, the fourth embodiment is formed by forming the grooves 45 or 46 on the bottom surface of the first layer 24a and the second layer 24b forming the liquid accumulating member 24 in the third embodiment 15 as shown in FIGS. 30A to 30D. However, the grooves 46 or 46 can be formed in other embodiment. For example, the V-shaped or U-shaped grooves may be formed on the bottom surface of the liquid accumulating member 4 of a single layer structure shown in the first embodiment. Even in this case, similar effect to the fourth embodiment can be expected.

(Fifth Embodiment)

Next, the fifth embodiment of the liquid transfer device according to the present invention will be discussed.

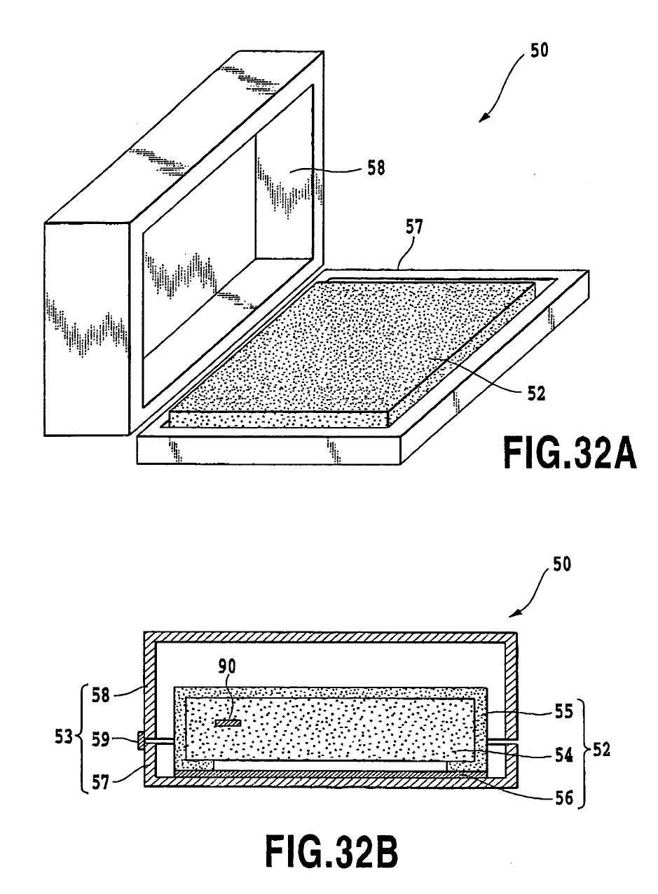

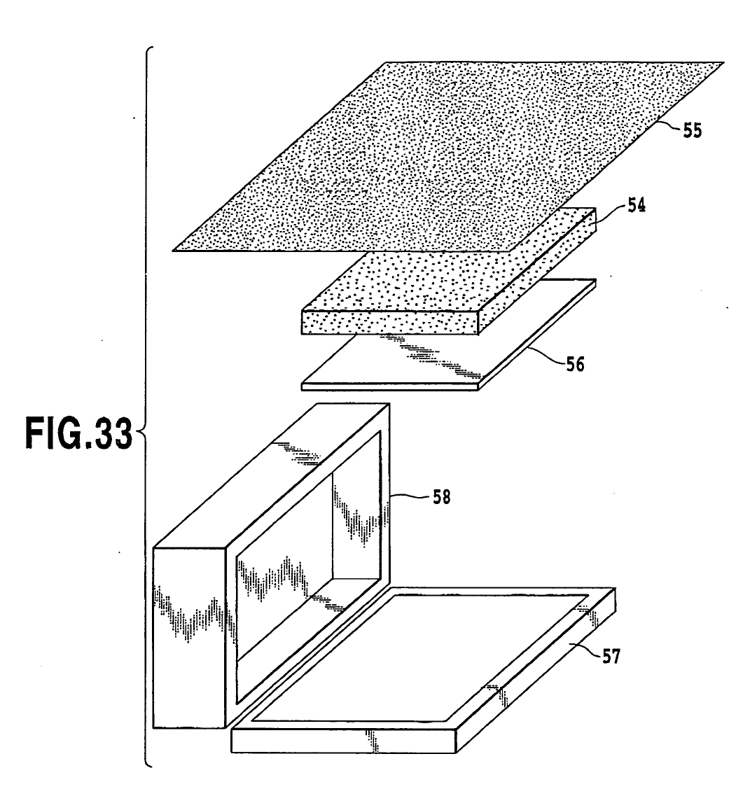

As shown in FIGS. 32A and 32B, the fifth embodiment of the liquid transfer device 50 is constructed with a liquid transfer member 52 transferring the liquid to the printed product, and the holding member 53 receiving and holding the liquid transfer member 52. The liquid transfer member 52 is formed with a quadrangular liquid accumulating member 54 formed from the fibrous body or foamed sponge, a porous film 55 covering top surface, side surfaces and a part of bottom surface of the liquid accumulating member 54 and a holding plate 56 covering the bottom surface of the porous film 55. Here, the porous film 55 is formed of the material similar to the foregoing embodiments. On the other hand, the holding member 53 is constructed with a lower casing portion 57 in quadrangular shape in plan view holding the liquid accumulating member 54, an upper casing portion 58 covering the opening portion of the lower casing portion 57 for opening and closing, and a hinge 59 connecting the both casing portions 57 and 58. Both casing portions are formed from a resin having rigidity or other material.

On the other hand, the holding plate 56 of the liquid accumulating member 52 is fixed to the inner surface of the bottom portion of the lower casing portion 57. In the condition where the upper casing 58 is opened, an upper half portion of the liquid accumulating member 52 is projected upwardly from the opening portion of the lower casing portion 57 to expose the transfer surface. On the other hand, by closing the upper casing body 58, the liquid accumulating member 52 is protected as being completely covered by both casing portions. Therefore, damaging, liquid leakage and so on due to exertion of an external force can be successfully avoided.

In use, the upper casing portion 58 is opened, and the printed product PM is mounted on porous member 55 in the transfer surface (liquid accumulating member) 52 projecting upwardly. Then the printed product PM is depressed by the pallet S to tightly fit the ink receptacle layer of the printed product PM onto the porous member to transfer the liquid. A dimension of the printed product which can be used, is not always required to be smaller than the area of the transfer surface but is applicable for the printed product having size greater than the transfer surface,

The liquid transfer device 50 may have the colored member 90 embedded in the liquid accumulating member 54 at a position overlapping with the porous film 55 (transfer zone) as viewed from right above. Then, since transmission coefficient of the liquid accumulating member 54 is varied (reduced) associating with increase of number of times of liquid transfer, view condition of the colored member 90 through the porous film 55 and the liquid accumulating member 54 is also varied (degraded) depending upon variation of transmission coefficient of the liquid accumulating member 54. Accordingly, even in the liquid transfer device 50, the user may monitor the liquid remaining amount in the liquid accumulating member 54 on the basis of the view condition of the colored member 90 through the porous film 55 and the liquid accumulating member 54. Thus, in the liquid transfer device 50, since viewing of the colored member 90 from the transfer zone side is permitted, it is not necessary to form the lower casing 57 of a transparent material.

[Sixth Embodiment]

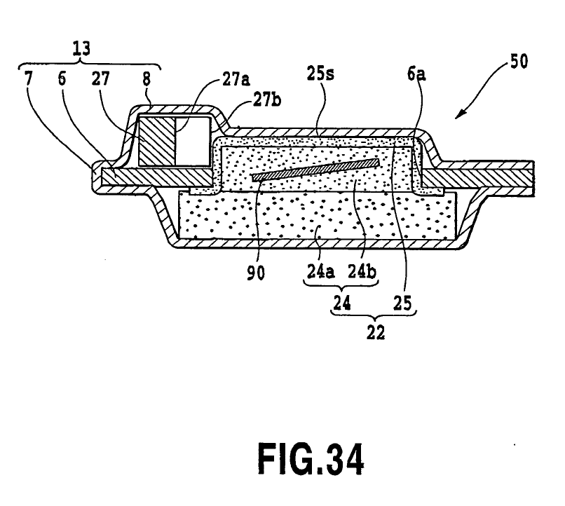

The sixth embodiment of the liquid transfer device according to the present invention will be discussed hereinafter with reference to FIGS. 34 to 37. It should be noted that like components to those discussed in connection with the embodiments will be identified by like reference numerals, and discussion for such common components will be eliminated for avoiding redundant disclosure.

In the liquid transfer device 50 shown in FIG. 34, as viewed from right above (on the side of the surface supporting frame 6), a colored member 90 is embedded in the high density layer 24b of the liquid accumulating member (absorbing body) 24 at a position overlapping with the porous film 5 (transfer zone) exposed through the opening portion 6a. Accordingly, the user may monitor the liquid remaining amount in the liquid accumulating member 24 on the basis of the view condition of the colored member 90 via the porous film 25 and the high density layer 24b. Then, in the liquid transfer device 50, the colored member 90 is arranged in tilted position in the high density layer 24b with respect to the surface (transfer surface) 25a of the porous film 25, namely in a condition continuously varying distance to the surface 25s of the porous film 25. In the shown embodiment, the colored member 90 is tilted in ascending manner to gradually reduce the distance to the surface 25s of the porous film 25 from an end portion proximal to the contact plate 27 toward an end portion on opposite side.

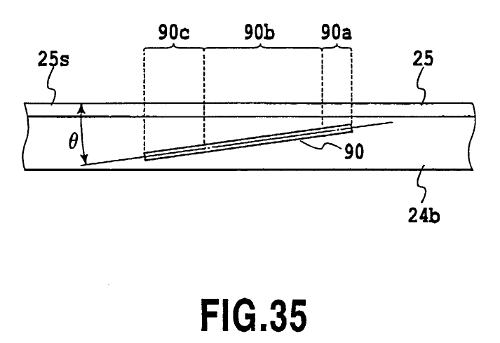

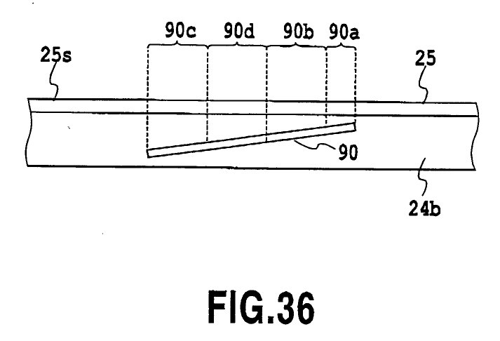

By this, view condition of the colored member 90 through the porous film 25 and the high density layer 24b is varied in a stepwise manner from the end portion proximal to the contact plate 27 toward the end portion on opposite side depending upon the distance between the surface 25s of the porous film 25 and the colored member 90 (volume of the high density layer 24b located therebetween). Namely, at a timing before start using or immediately after starting of using of the liquid transfer device 50 and thus the liquid is sufficiently filled in the liquid accumulating member 24, the colored member 90 viewed through the porous film 25 and the high density layer 24b is substantially separated into a constantly transmitted region 90a, a variably transmitted region 90b and a constantly not transmitted region 90c, as shown in FIG. 35.

The constantly transmitted region 90a is a region to be constantly viewed through the porous film 25 and the high density layer 24b irrespective of presence or absence of the liquid in the high density layer 24b. On the other hand, the variably transmitted region 90b is a region varying view condition through the porous film 25 and the high density layer 24b according to variation of transmission coefficient of the high density layer 24b depending upon amount of the liquid held in the high density layer 24b. The constantly not transmitted region 90c is a region constantly not viewed through the porous film 25 and the high density layer 24b irrespective of presence or absence of the liquid in the high density layer 24b.

Here, a length of the variably transmitted region 90b before starting use of the liquid transfer device 50 is determined depending upon an angle e between the surface 25s of the porous film 25 and the colored member 90. In the shown embodiment, the colored member 90 is formed to have 5 mm in width and 15 mm in length and is embedded in the high density layer 24b to have the angle θ, about 4 degree, relative to the surf ace 25s of the porous film 25. The dimension, shape of the colored member 90 and the angle θ between the surface 25s of the porous film 25 and the colored member 90 are determined in such a manner ensuring visual perceptivity through the porous film 25 and the high density layer 24b with avoiding interference of flow of liquid in the liquid accumulating member 24. On the other hand, in the shown embodiment, the colored member 90 may be formed by a thin sheet having a plurality of apertures. By this, interference of flow of the liquid in the liquid accumulating member 24 by presence of the colored member 90 can be certainly avoided.

In the liquid transfer device 50 constructed as set forth above, at a stage before starting use of the liquid transfer device 50, a predetermined length of the variably transmitted region 90b and constantly not transmitted region 90c are viewed from the porous film 25 side When use of the liquid transfer device 50 is started and number of times of transfer of liquid is increased, the amount of liquid in the liquid holding member 24 is reduced to lower transmission coefficient of the high density layer 24b. By this, associating with reduction of amount of the liquid stored in the liquid holding member 24, the length of the variably transmitted region 90b is reduced to form new not transmitted region 90d between the variably transmitted region 90b and the constantly not transmitted region 90c, as shown in FIG. 36.

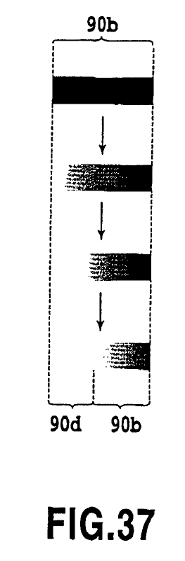

Namely, when the colored member 90 is viewed from right above (on the surface supporting frame 6 side) via the porous film 25, the length of the variably transmitted region 90b of the colored member 90 gradually becomes smaller according to increasing of number of times of transfer of the liquid, and the not transmitted region 90d is increased, as can be appreciated from FIG. 37. Accordingly, by monitoring the colored member 90 (variably transmitted region 90b), the user may make judgment of the liquid remaining amount in the liquid accumulating member 24. In the shown embodiment of the liquid transfer device 50, at the stage where the predetermined number of times of transfer is completed (for example, about 100 times), only constantly transmitted region 90a can be viewed from the porous film 25 side. Accordingly, the user recognize that little amount of liquid is left in the liquid accumulating member 24 at the stage where size of the colored member 90 viewed through the porous film 25 and the high density region 24b is not varied.

It should be noted that, in the liquid transfer device 50, a relationship between the view condition of the colored member 90 (lengthes of the constantly transmitted region 90a, variably transmitted region 90b and constantly not transmitted region 90c) and liquid remaining amount in the liquid accumulating member 24b can be adjusted by varying the thickness of the high density layer 24b of the liquid accumulating member 24 and/or embedding height of the colored member 90 in the high density region 24b. Accordingly, by appropriately setting a minimum distance between the surface 25S of the porous film 25 and the colored member 90 in view of characteristics of the liquid and transmission coefficient of the high density layer 24b, it becomes possible to make the colored member 90 invisible from the porous film 25 side at the stage where the predetermined number of times of liquid transfer is completed. Also, in the shown embodiment, it is possible to embed the colored member 90 in the high density layer 24b so as not to overlap with the porous film 5 (transfer zone) exposed from the opening portion 6a.

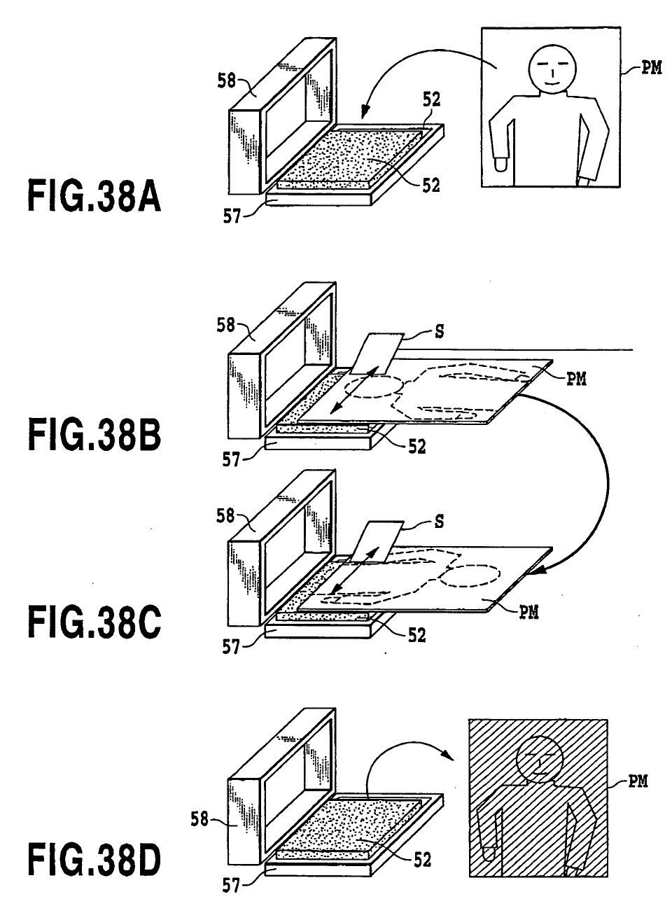

By the way, FIGS. 38A to 38D are illustrations showing liquid transfer operation for a large size printed product larger than the transfer surface. For the large size printed product PM shown in FIG. 38A, liquid may be transferred over the entire area of the large size printed product PM by shifting the printed product relative to the transfer surface for a plurality of times as shown in FIGS. 38B and 38C. In this case, it is possible that the liquid is transferred in overlapping manner in certain regions of the printing medium. However, since the region where the liquid has been transferred once is lowered the liquid holding ability (capillary force) of the printed product, the liquid may not be transferred in excessive amount even by overlapping transfer. Therefore, it is not necessary to consider degradation of image by the overlapping transfer.

By performing transfer with dividing into small regions, appropriate liquid transfer can be easily performed even for the large size printed product.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. A liquid transfer device transferring liquid for enhancing durability of an image on a printed surface of a printed product printed with ink, comprising:
a liquid transfer member having a transfer surface contacting the printed surface of said printed product and transferring the liquid on the printed surface of said printed product,
said liquid transfer member including
a liquid accumulating portion accumulating the liquid; and
a restricting portion supplying the liquid in said liquid accumulating portion to said transfer is surface with restriction.

2. The liquid transfer device as claimed in claim 1, wherein said restricting portion is formed from a porous film formed with fine pores.

3. The liquid transfer device as claimed in claim 2, which further comprises a holding member for receiving and holding said liquid transfer member.

4. The liquid transfer device as claimed in claim 1, wherein said liquid accumulating portion is formed from a sheet form member having uniform density.

5. The liquid transfer device as claimed in claim 3, wherein said holding member includes a surface supporting frame formed with an opening portion exposing said restricting portion and a dish shaped receptacle member having a flange mating with a lower surface of said surface supporting frame, said liquid transfer member is received within a receptacle space defined by said receptacle member and said surface supporting frame.

6. The liquid transfer device as claimed in claim 1, wherein said liquid accumulating portion is formed from a sheet form member having different density in thickness direction thereof.

7. The liquid transfer device as claimed in claim 6, wherein said liquid accumulating portion is formed from a sheet form member provided with treatment for continuously varying a density in thickness direction with a predetermined gradient.

8. The liquid transfer device as claimed in claim 6, wherein said liquid accumulating portion is formed by laminating a plurality of sheet form members having different densities.

9. The liquid transfer device as claimed in claim 2, wherein capillary forces of said liquid accumulating portion, said porous film and the printed surface of said printed product are set for establishing a relationship: liquid accumulating portion <porous film <printed surface of printed product.

10. The liquid transfer device as claimed in claim 8, wherein densities of respective sheet form members forming said liquid accumulating portion are set for producing greater capillary force at closer position to said transfer surface.

11. The liquid transfer device as claimed in claim 7, wherein said liquid accumulating portion is formed with a first layer and a second layer having different densities, said first layer is located at a position more distant from said transfer surface than said second layer, and said first layer has greater density than said second layer.

12. The liquid transfer device as claimed in claim 11, which further comprises a holding member receiving said liquid transfer member, said holding member includes a surface supporting frame having an opening portion, into which said first layer covered with said restricting portion is inserted, and a dish shaped receptacle member having a flange mating with a lower surface of said surface supporting frame,
said second layer is received with a receptacle space defined by said receptacle member and said surface supporting frame and said first layer covered by said restricting portion projects upwardly from a surface of said surface supporting frame, and a surface of said restricting portion forms a transfer zone.

13. The liquid transfer device as claimed in claim 11, wherein said first layer and said second layer are formed from a fibrous body or a foamed sponge body, a density of said first layer is in a range of 0.05 to 0.5 g/cc, and a density of said second layer is in a range of 0.01 to 0.2 g/cc.

14. The liquid transfer device as claimed in claim 2, wherein said porous film has a thickness of 10 to 200 μm, and a diameter of fine pore is 0.1 to 3 μm.

15. The liquid transfer device as claimed in claim 1, wherein said liquid transfer member has a normally flat transfer surface, when the printed product is mounted and urged onto said transfer surface, said liquid accumulating portion is elastically deformed corresponding to a curved shape of the printed surface of said printed product so that said curved printed surface and said transfer surface are contacted over entire area.

16. The liquid transfer device as claimed in claim 15, wherein stripe form grooves are formed on a bottom surface of said liquid accumulating portion.

17. A liquid holding device holding a liquid by capillary force, comprising:
a plurality of divided liquid holding members, each holding the liquid by capillary force thereof,
wherein each of the plurality of divided liquid holding members are determined in capillary force and size so that a total liquid amount to be held by said divided liquid holding members is greater than a liquid amount to be held by a liquid holding member before division, irrespective of attitude of said liquid holding device.

18. The liquid holding device as claimed in claim 17, wherein each of the plurality of liquid holding members is determined in size so as to hold the liquid over substantially entire region of said liquid holding member irrespective of attitude of said liquid holding device.

19. A liquid transfer device transferring liquid to an object to be transferred the liquid, comprising:
a transfer film permeating said liquid and contacting said object to be transferred the liquid for transferring the permeating liquid; and
an accumulating portion including a plurality of divided accumulating members accumulating the liquid to be supplied to said transfer film and permeating therethrough, by capillary forces thereof, each of said plurality of accumulating members having such capillary forces and sizes that a total liquid amount to be held by said divided liquid holding members is greater than a liquid amount to be held by a liquid holding member before division, irrespective of attitude of said liquid holding device.

20. The liquid transfer device as claimed in claim 19, wherein each of said plurality of liquid accumulating members is set at a size for accumulating the liquid over substantially entire region of said liquid accumulating member irrespective of attitude of said liquid transfer device.

21. The liquid transfer device as claimed in claim 19, wherein said plurality of liquid accumulating members are dividedly arranged so that liquids accumulated in each of said plurality of liquid accumulating members are communicated with each other as depressed through said transfer film.

22. The liquid transfer device as claimed in claim 19, wherein said plurality of liquid accumulating members are separated from each other by partitioning walls.

23. The liquid transfer device as claimed in claim 22, wherein thicknesses of said partitioning walls are in a range of 0.1 mm to 1 mm.

24. The liquid transfer device as claimed in claim 23, wherein said plurality of liquid accumulating members are processed at an accuracy so that a length of burr possibly formed during processing becomes less than the thickness of said partitioning wall.

25. A liquid transfer device transferring a predetermined liquid to an object to be transferred the liquid, comprising:
a porous body having a transfer zone to be contacted with said object to be transferred the liquid;
an absorbing body arranged in contact with said porous body and capable of absorbing and holding the liquid; and
a colored member embedded in said absorbing body and being visible through said absorbing body,
wherein a liquid remaining amount in said absorbing body can be monitored on the basis of view condition of said colored member variable depending upon transmission coefficient of said absorbing body variable according to increase number of times of transfer of said liquid.

26. The liquid transfer device as claimed in claim 25, wherein said absorbing body is supported by an essentially transparent receptacle member, and said colored member is visible through said receptacle member and said absorbing body.

27. The liquid transfer device as claimed in claim 25, wherein said absorbing body includes a first absorbing body having a first density and a second absorbing body having a second density lower than said first density, and said colored member is visible through said second absorbing body.

28. The liquid transfer device as claimed in claim 25, wherein an embedding height of said colored member in said absorbing body is determined so as to detect lacking of liquid remaining amount in said absorbing body from view condition of said colored member at a timing where a predetermined times of liquid transfer is completed.

29. The liquid transfer device as claimed in claim 28, wherein said absorbing body includes a first absorbing body and a second absorbing body, and thickness of at least one of said first absorbing body and said second absorbing body is determined so as to detect lacking of remaining liquid amount in said absorbing body from view condition of said colored member at a timing where a predetermined times of liquid transfer is completed.

30. The liquid transfer device as claimed in claim 25, wherein said colored member has a plurality of holes permitting flow of said liquid.

31. The liquid transfer device as claimed in claim 25, wherein said colored member has an external dimension of at least 5 mm square.

32. The liquid transfer device as claimed in claim 25, wherein said colored member is embedded in said absorbing body at a position not overlapping with said transfer zone.

33. The liquid transfer device as claimed in claim 25, wherein said colored member is embedded in said absorbing body at a position overlapping with said transfer zone.

34. The liquid transfer device as claimed in claim 25, wherein said colored member is embedded in said absorbing body in a tilted state relative to the surface of said porous body so that lacking of liquid remaining amount in said absorbing body can be perceived from view condition of said colored member at a time of completion of transfer for a predetermined number of times.

35. The liquid transfer device as claimed in claim 34, wherein said colored member can be seen through said porous body and said absorbing body.

36. The liquid transfer device as claimed in claim 34, wherein said absorbing body includes a first absorbing body having a first density and a second absorbing body having a second density lower than said first density, thickness of at least one of said first absorbing body and said second absorbing body is determined so that lacking of liquid remaining amount in said absorbing body can be perceived from viewing condition of said colored member at a time of completion of transfer for a predetermined number of times.

37. The liquid transfer device as claimed in claim 34, wherein said colored member has a plurality of holes permitting flow of said liquid.

38. A liquid remaining amount monitoring method of a liquid transfer device having a porous body having a transfer zone contacting an object to be transferred liquid and an absorbing body arranged in contact with said porous body and capable of absorbing and holding a predetermined liquid, and transferring said liquid to said object arranged in said transfer zone, wherein said method comprising the steps of:
embedding a colored member in said absorbing body to be viewed through said absorbing body, and
monitoring a liquid remaining amount in said absorbing body on the basis of view condition of said colored member depending upon a transmission coefficient of said absorbing body variable according to increase of number of times of transfer of said liquid.

39. The liquid remaining amount monitoring method as claimed in claim 38, wherein said colored member is embedded in said absorbing body in a tilted state relative to the surface of said porous body.

40. A liquid transfer device transferring liquid for enhancing durability of an image for a printed surface of a printed product printed with ink, comprising:
a liquid transfer member transferring said liquid to the printed surface of a printing medium by contacting the printed surface of said printing medium on a transfer surface externally exposed,
said liquid transfer member having a liquid accumulating member accumulating the liquid by capillary force and having a primary surface positioning said transfer surface at an upper portion, said liquid accumulating member having a dimension greater than a dimension where an initial accumulation amount corresponding to a predetermined number of times to transfer the liquid becomes a maximum absorbing capacity.

41. The liquid transfer device as claimed in claim 40, wherein said liquid accumulating member is determined a dimension so that an amount of the liquid to be held without causing leakage even upon exposing to atmosphere becomes said initial accumulation amount.

42. The liquid transfer device as claimed in claim 40, wherein said liquid accumulating member is determined a dimension so that an amount of the liquid to be held without causing leakage even when the primary surface is oriented in vertical direction, becomes said initial accumulation amount.

43. The liquid transfer device as claimed in claim 40, wherein said liquid accumulating member is determined a dimension in a direction of said primary surface so that said primary surface becomes larger than said transfer surface.

44. The liquid transfer device as claimed in claim 41, wherein said liquid accumulating member has a layer having relatively high density and in which said transfer surface is positioned, and a layer having relatively low density and in which said primary surface is arranged, said liquid accumulating member is determined a dimension so that a sum of the amounts of liquid to be held without causing leakage in each of said layers becomes said initial accumulation amount.

45. The liquid transfer device as claimed in claim 42, wherein said liquid accumulating member has a layer having relatively high density and in which said transfer surface is positioned, and a layer having relatively low density and in which said primary surface is arranged, said liquid accumulating member is determined a dimension so that a sum of the amounts of liquid to be held without causing leakage in each of said layers becomes said initial accumulation amount.

46. The liquid transfer device as claimed in claim 40, wherein a dimension of said layer having relatively low density in a direction of said primary surface is determined so that said primary surface of said layer having relatively low density is larger than a bottom surface of said layer having relatively high density where said transfer surface is positioned and mating with said primary surface.

47. The liquid transfer device as claimed in claim 40, wherein a porous film formed with fine pores restrictingly supplying the liquid exuding from said liquid accumulating member, is arranged on said transfer surface.

48. The liquid transfer device as claimed in claim 47, wherein said initial accumulation amount is determined with taking an amount of liquid to be held by said porous film without causing leakage, and the dimension of said liquid accumulating member is determined corresponding to said initial accumulation amount.

49. The liquid transfer device as claimed in claim 40, wherein grooves for smoothly moving said liquid to the position corresponding to said transfer surface are provided in said liquid accumulating member.

50. A liquid transfer method for transferring liquid enhancing durability of an image to a printed surface of a printed product printed with ink, comprising the steps of:
providing a liquid accumulating portion accumulating the liquid and a restricting portion restrictingly supplying the liquid in said liquid accumulating portion to a transfer surface contacting the printed surface of said printed product, and
transferring the liquid supplied through said restricting portion by mounting the printed surface of said printed product on said transfer surface in contact therewith.

51. The liquid transfer method as claimed in claim 50, wherein said printed surface of said printed product has an area greater than said transfer surface, and said printed surface is contacted with said transfer surface dividedly for a plurality of times.

52. A liquid transfer method transferring a liquid to an object to be transferred the liquid, comprising the steps of:
providing a liquid transfer device having a transfer film permeating said liquid and transferring the permeated liquid in contacting with said object, and an accumulating portion accumulating the liquid to be supplied to said transfer film and permeated therethrough and having a plurality of divided accumulating members, each of said accumulating members being determined a capillary force and a size so that a total liquid amount accumulated in said plurality of divided accumulating members becomes greater than a liquid amount to be accumulated in the accumulated portion before division irrespective of attitude of said liquid transfer device; and
in transferring the liquid to said object, communicating liquids accumulated in each of said plurality of accumulating members with each other by depressing said plurality of accumulating members through said transfer film by urging said object onto said transfer film.

53. The liquid transfer method as claimed in claim 52, wherein each of said plurality of liquid accumulating members is determined in size so as to accumulate over substantially entire region of said liquid accumulating member irrespective of the attitude of said liquid transfer device.

54. A liquid transfer method for transferring liquid for enhancing durability of an image for a printed surface of a printed product printed with ink, comprising:
providing a liquid transfer device defined in any one of claims 40 to 49;
mounting said printed product in a condition where said transfer surface mates with said printed surface; and
performing said transfer by applying said liquid to said printed surface via said transfer surface from said liquid accumulating member.
